(19) United States
(12) Patent Application Publication
(10) Pub. No.: US 2023/0372812 A1
(43) Pub. Date: Nov. 23, 2023

(54) METHOD AND APPARATUS FOR DATA SYNCHRONIZATION, DEVICE AND MEDIUM

(71) Applicant: Tencent Technology (Shenzhen) Company Limited, Shenzhen (CN)

(72) Inventors: Huaguan MA, Shenzhen (CN); Wei HUANG, Shenzhen (CN); Xiaofang LIU, Shenzhen (CN); Xinghua LI, Shenzhen (CN); Zhaohong CHEN, Shenzhen (CN); Linran TAO, Shenzhen (CN); Lvming JIAO, Shenzhen (CN); Fangzhou LIU, Shenzhen (CN); Wan HAO, Shenzhen (CN); Yirong SUN, Shenzhen (CN); Tianlan HUANG, Shenzhen (CN); Xibin LI, Shenzhen (CN); Dingxun WANG, Shenzhen (CN)

(21) Appl. No.: 18/220,776

(22) Filed: Jul. 11, 2023

Related U.S. Application Data
(63) Continuation of application No. PCT/CN2022/120820, filed on Sep. 23, 2022.

(30) Foreign Application Priority Data
Nov. 19, 2021 (CN) 202111399015.6

(51) Int. Cl. A63F 13/352

(52) U.S. Cl. CPC A63F 13/352

(57) ABSTRACT

This application provides a method for performing inter-app data synchronization in a service management platform. The method includes: creating a state machine for a platform virtual room containing a target object in the service management platform; creating a service virtual room in an application through the state machine, and adding the target object into the service virtual room; receiving service progress data of the target object in the service virtual room through the state machine and updating the state machine accordingly to obtain a state-updated state machine; and performing data synchronization processing on the platform virtual room according to the state-updated state machine and the service progress data of the service virtual room so as to synchronize object service information of the target object in the service virtual room into the platform virtual room.

### CROSS-REFERENCE TO RELATED APPLICATIONS

This application is a continuation application of PCT Patent Application No. PCT/CN2022/120820, entitled “METHOD AND APPARATUS FOR DATA SYNCHRONIZATION, DEVICE AND MEDIUM” filed on Sep. 23, 2022, which claims priority to Chinese Patent Application No. 202111399015.6, entitled “METHOD AND APPARATUS FOR DATA DISPLAY, DEVICE AND MEDIUM” filed to the Chinese Patent Office on Nov. 19, 2021, all of which is incorporated herein by reference in its entirety.

### FIELD OF THE TECHNOLOGY

This application relates to the technical field of Internet, in particular, to a method and apparatus for data synchronization, a device and a medium.

### BACKGROUND OF THE DISCLOSURE

As for a current application, a set of service activity system may be created in the application, for example, a competing system, the service activity system may support forming a team of users and match formed teams for participating in a service activity, that is, the service activity system is used for meeting a demand of users for participating in a service activity. For example, when the users need to participate in a competition activity (namely, a competition), competing may be performed in the service activity system of each application respectively, a competing result is recorded in a specific mode (for example, a screenshot and the like) after competing ends, the competing result is manually uploaded to an activity execution party, the competing result of the users is manually typed in by the activity execution party, and a competition progress of the users also needs to be manually pushed.

### SUMMARY

An embodiment of this application provides a method and apparatus for data synchronization, a device and a medium, which can improve efficiency of synchronization processing of information.

One aspect of an embodiment of this application provides a method for data synchronization, performed by a computer device running a service management platform and including:
creating a state machine for a platform virtual room containing a target object in the service management platform;
creating a service virtual room in an application through the state machine, and adding the target object into the service virtual room;
receiving service progress data of the target object in the service virtual room through the state machine and updating the state machine accordingly to obtain a state-updated state machine; and
performing data synchronization processing on the platform virtual room according to the state-updated state machine and the service progress data of the service virtual room so as to synchronize object service information of the target object in the service virtual room into the platform virtual room.

One aspect of an embodiment of this application provides a computer device, including a memory and a processor, the memory being connected to the processor and configured to store a computer program that, when executed by the processor, causes the computer device to perform the method provided by the above one aspect in this embodiment of this application.

One aspect of an embodiment of this application provides a non-transitory computer-readable storage medium, storing a computer program that, when executed by a processor of a computer device, causes the computer device to perform the method provided by the above one aspect in this embodiment of this application.

### BRIEF DESCRIPTION OF THE DRAWINGS

FIG. 1 is a schematic structural diagram of a network architecture provided by an embodiment of this application.

FIG. 2 is a diagram of a data synchronization processing scenario provided by an embodiment of this application.

FIG. 3 is a schematic flowchart of a method for data synchronization provided by an embodiment of this application.

FIG. 4 is a schematic structural diagram of a state machine provided by an embodiment of this application.

FIG. 5 is a schematic diagram of data synchronization processing between a platform virtual room and a service virtual room provided by an embodiment of this application.

FIG. 6 is a schematic diagram of data synchronization processing between a platform virtual room and a service virtual room provided by an embodiment of this application.

FIG. 7 is a schematic diagram of data synchronization processing between a platform virtual room and a service virtual room provided by an embodiment of this application.

FIG. 8 is a schematic flowchart of a method for data synchronization provided by an embodiment of this application.

FIG. 9 is a schematic diagram of the number of states of a hierarchical state machine provided by an embodiment of this application.

FIG. 10 is a schematic diagram of selection of a recognition model provided by an embodiment of this application.

FIG. 11 is a schematic diagram of gradient descent provided by an embodiment of this application.

FIG. 12 is a schematic diagram of training of a recognition model provided by an embodiment of this application.

FIG. 13 is a schematic sequence chart of synchronization of object service information in a service management platform provided by an embodiment of this application.

FIG. 14 is a schematic flowchart of management of a recognition model in a service management platform provided by an embodiment of this application.

FIG. 15 is a schematic structural diagram of an apparatus for data synchronization provided by an embodiment of this application.

FIG. 16 is a schematic structural diagram of a computer device provided by an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts fall within the protection scope of this application.

This application involves the following several concepts.

State machine: the state machine is a shortened form for a finite state automaton and is a mathematical calculation model for representing a finite number of states and behaviors such as transition and action between the states.

Service activity system (also called competing system): the service activity system may meet a demand of users for grouping in a process of using an application and supports dividing a plurality of users into different user groups. For example, as for a game application, the service activity system may be also called the competing system. The competing system may complete a demand of the users for fighting, and may support functions such as team forming of the users, making a competition schedule, fighting and information synchronization and provide a one-stop service for a competitor fighting solution.

A multi-service activity platform (also called a multi-game-event platform): the multi-game-event platform is an event system which may support a large number of participants, support event sign-up, event team forming, event grouping, event competition creating, game event competition creating, game event competing result pull, competition schedule progress push and other functions and provide capability of whole-process automated pushing of a competition schedule.

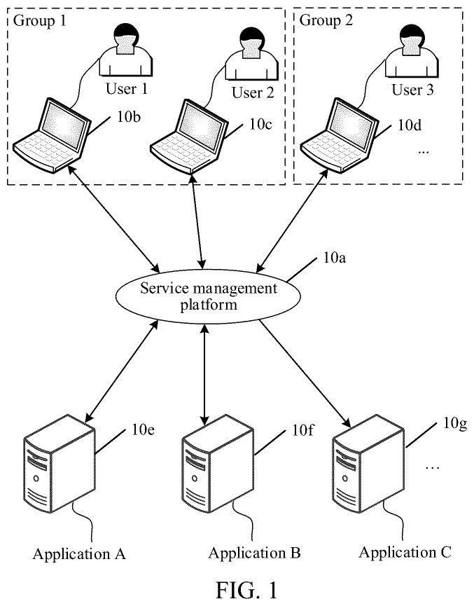

Please refer to FIG. 1, FIG. 1 is a schematic structural diagram of a network architecture provided by an embodiment of this application. As shown in FIG. 1, the network architecture may include a server cluster, a service management platform 10a and a user terminal cluster. The service management platform 10a may be the multi-game-event platform or a competing system, which is not limited in this application. The server cluster may include one or more servers. The user terminal cluster may include one or more user terminals. The number of the servers and the number of the user terminals are not limited here. As shown in FIG. 1, the user terminal cluster may specifically include a user terminal 10b, a user terminal 10c, a user terminal 10d and the like. Each user terminal in the user terminal cluster may refer to an electronic device used by a user participating in an activity, for example, the user terminal 10b is the electronic device used by the user 1, the user terminal 10c is the electronic device used by the user 2, and the user terminal 10d is the electronic device used by the user 3. The server cluster may specifically include a server 10e, a server 10f, a server 10g and the like. Each server in the server cluster may be a background server of an application accessing the service management platform 10a, and different servers may represent background servers corresponding to different applications, that is, one or more applications may access the service management platform 10a. For example, the server 10e may be the background server corresponding to the application A, the server 10f may be the background server corresponding to the application B, the server 10g may be the background server corresponding to the application C, and service activities of applications such as the application A, the application B and the application C may be supported in the service management platform 10a. In the service management platform 10a, the users may sign up to participate in the service activity of each application, one or more users in the service management platform 10a may form one group, each group may include one or more users, the number of the users contained in each group is associated with an activity rule of the application to which the service activity the group sign ups to participate in belongs, for example, the user 1 and the user 2 may form a group 1 in the service management platform 10a, the user 3 may form a group 2 in the service management platform 10a, and the group 1 and the group 2 may be groups in the service activity of the same application or groups of the service activities of the different applications. The number of the users in each group is not limited in this application.

The server 10e, the server 10f, the server 10g and the like may be standalone physical servers, or a server cluster composed of a plurality of physical servers or a distributed system, or may also be a cloud server providing a cloud service, a cloud database, cloud computing, a cloud function, cloud storage, a network service, cloud communication, a middleware service, a domain name service, a security service, CDN, big data, an artificial intelligence platform and other basic cloud computing services. The user terminal 10b, the user terminal 10c, the user terminal 10d and the like may each include: a smartphone, a tablet computer, a notebook computer, a palmtop computer, a mobile interne device (MID), a wearable device (such as a smartwatch and a smart bracelet), a smart speech competing device, smart household electrical appliances (such as a smart television), a vehicle-mounted terminal and other electronic devices.

In the embodiments of this application, one or more applications may access the service management platform. The users, when intending to participate in the service activities of these applications, may have services of activity sign-up, activity team forming, activity grouping, activity competition creating (namely, creation of a platform virtual room), application activity competition creating (namely, creation of a service virtual room), activity result pull, activity progress push and the like. A state machine is created for each activity competition (namely, the platform virtual room) in the service management platform, and data of the service virtual room may automatically access the platform virtual room of the service management platform through the state machine, so that the activity competition in the service management platform may automatically run in a whole process, that is, the data synchronization between the platform virtual room and the service virtual room may be implemented through the state machine, a tedious operation of manual typing in data is omitted, and efficiency of synchronization processing of information may be improved. The service management platform may support the service activities of one or more applications, so universality of the service management platform may be improved.

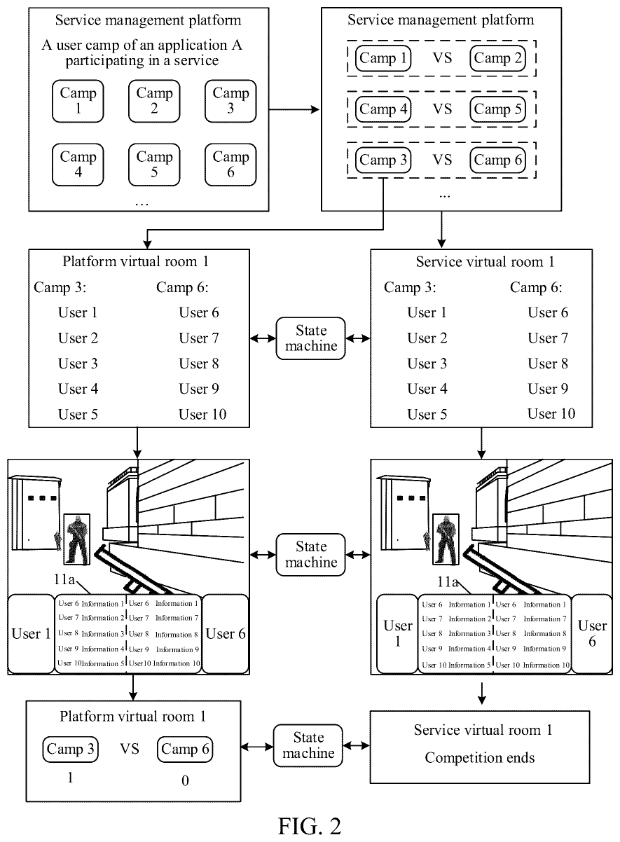

Please refer to FIG. 2, FIG. 2 is a diagram of a data synchronization processing scenario provided by an embodiment of this application. This embodiment of this application describes a data synchronization processing process in the service management platform in detail by taking a shooting game as an example. The service management platform shown in FIG. 2 may be the multi-game-event platform, the application A may be the shooting game, a user intending to participate in the game event of the application A may conduct event sign-up in the service management platform and complete an operation of forming camps in the service management platform, and each camp may include one or more users, for example, the game event of the application A may include a camp 1, a camp 2, a camp 3, a camp 4, a camp 5, a camp 6 and other participating teams. In other words, according to a game event rule of the application A, the user signing up to participate in the game event of the application A participates in a form of an individual or a team, the number of the users contained in each camp may be the same or not, and the number of the users contained in each camp is not limited in this application.

In the service management platform, all participating teams in the game event of the application A may match, the participating teams which match successfully are competing camps against each other, and the number of the camps being the competing camps against each other is not limited in this application. As shown in FIG. 2, description is made by taking the number of the competing camps against each other being 2 as an example, for example, the camp 1 and the camp 2 matching successfully means that the camp 1 and the camp 2 are the competing camps against each other. The camp 4 and the camp 5 matching successfully means that the camp 4 and the camp 5 are the competing camps against each other. The camp 3 and the camp 6 matching successfully means that the camp 3 and the camp 6 are the competing camps against each other. Two camps against each other may create the corresponding platform virtual room in the service management platform. For example: the platform virtual room 1 may be created in the service management platform for the camp 3 and the camp 6 which are the competing camps against each other, and the platform virtual room 1 may include all the users in the camp 3 and the camp 6, for example, containing the user 1, the user 2, the user 3, the user 4 and the user 5 in the camp 3 as well as the user 6, the user 7, the user 8, the user 9 and the user 10 in the camp 6. Further, the state machine may be created for the platform virtual room 1 in the service management platform and may be configured to execute switching between game states in the application A, and one platform virtual room may correspond to one state machine. The service virtual room 1 may be created in the application A through the state machine, all the users in the platform virtual room 1 are added into the service virtual room 1, that is, through the state machine in the service management platform, the users belonging to the same platform virtual room (such as the platform virtual room 1) in the service management platform may be added into the same service virtual room (such as a game virtual room 1) in the application A. In some embodiments, all the users added into the game virtual room 1 may select game virtual persons suitable for their own needs, skills corresponding to the game virtual persons, and the like.

When the users in the game virtual room 1 trigger game start information (namely, service start information) in the game virtual room 1, a state of the state machine may be driven to switch to a state of “playing”, at the moment, service progress data (such as game progress data) in the game virtual room 1 may be obtained in real time through the state machine, and data synchronization processing is performed on the platform virtual room 1 based on the game progress data and the state machine. For example, a video picture in the game virtual room 1 is a real-time competing picture (such as the above game progress data) between the user 1 in the camp 3 and the user 6 in the camp 6, user information corresponding to each user in the camp 3 and the camp 6 may also be displayed in real time in the game virtual room 1, as shown in a region 11a in the game virtual room 1, and the user information here may refer to parameter information such as the number of times of shooting, the number of times of being shot and a skill state of the corresponding users in the game virtual room 1. Through the game progress data of the camp 3 and the camp 6 in the game virtual room 1 and the state machine, the service management platform may perform data synchronization processing on the platform virtual room 1, that is, a content shown in the platform virtual room 1 may include the video picture in the game virtual room 1, and the user information corresponding to each user in the camp 3 and the camp 6. In other words, when the state of the state machine switches to “playing”, data synchronization processing between the platform virtual room 1 and the game virtual room 1 may be implemented through the state machine.

When a competition between the camp 3 and the camp 6 in the game virtual room 1 ends, the state of the state machine may be driven to switch to a state of “read a competing result”, based on the state machine in the state of “read a competing result”, the service management platform may obtain a competing result of the camp 3 and the camp 6 in the game virtual room 1, and the competing result between the camp 3 and the camp 6 may be shown in the platform virtual room 1, for example, when the camp 3 defeats the camp 6 in the game virtual room 1, the competing result between the camp 3 and the camp 6 shown in the platform virtual room 1 is 1:0. In some embodiments, the camp 3 and the camp 6 may also continue to start a new game competition in the game virtual room 1 till an event competition between the camp 3 and the camp 6 is finished. Data synchronization processing between the game virtual room 1 in the application A and the platform virtual room 1 in the service management platform may be implemented through the state machine, and the efficiency of synchronization processing of game competing information may be improved.

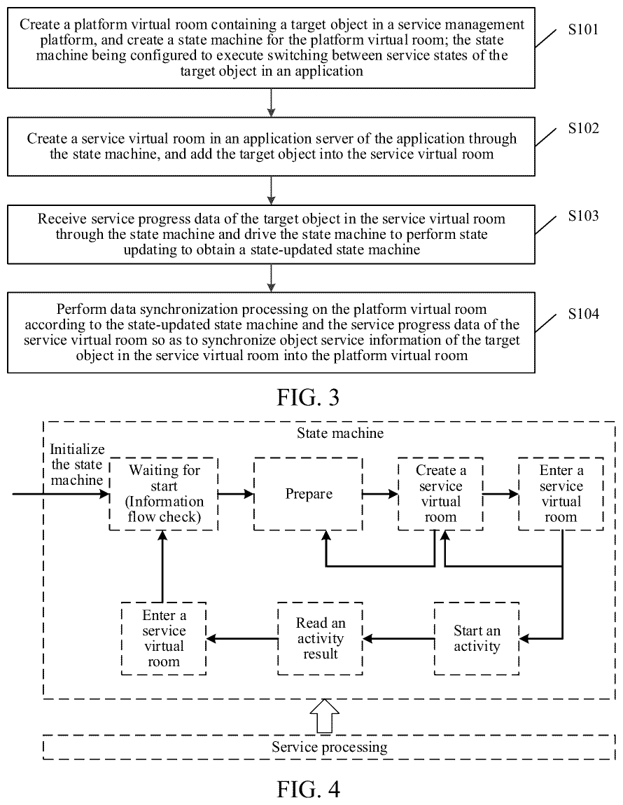

Please refer to FIG. 3, FIG. 3 is a schematic flowchart of a method for data synchronization provided by an embodiment of this application. It may be understood that the method for data synchronization may be executed by a computer device, and the computer device may be a user terminal or a server running the service management platform. As shown in FIG. 3, the method for data synchronization may include the following step S101 to step S104.

Step S101: Create a platform virtual room containing a target object in the service management platform, and create a state machine for the platform virtual room; the state machine being configured to execute switching between service states of the target object in an application.

Specifically, a target user, when intending to participate in an activity of a certain application, may submit personal sign-up information in the service management platform for activity sign-up, and the computer device may obtain the personal sign-up information submitted by the target user, determine that the target user signs up successfully when the personal sign-up information meets a sign-up condition and record all users signing up successfully in the service management platform. The target user signing up successfully may participate in the activities in the service management platform on the premise of following the activity rules in a form of an individual or a camp.

In some embodiments, the target user, when participating in the activity in a form of a camp, may invite other users signing up successfully in the service management platform to form a team (also called forming a camp), or the target user may apply for joining a camp that is not full, a team leader of each camp (the team leader is a user in the camp) may sign up as a representative of the entire camp, that is, the team leader may submit camp sign-up information in the service management platform on behalf of the entire camp to participate in the activity in a form of a camp.

As for all camps signing up to participate in the activities in the service management platform, the computer device may divide all the sign-up camps into groups, the camps in the same group may compete as opponents of the activity, one camp may match one camp as an opponent or match a plurality of camps as opponents, and the number of opponent camps against one camp may be determined according to an actual rule of the activity and is not limited in this application. In the service management platform, the camps may be divided into groups according to a preset distribution rule, or all the camps may be randomly divided into groups, and the distribution rule for the camps is not limited in this application.

When the first camp and the second camp in the service management platform are distributed as opponents, the computer device may create the platform virtual room in the service management platform for the first camp and the second camp, and at the moment, the first camp and the second camp may be called target objects, that is, the platform virtual room may be created in the service management platform for the target objects. The platform virtual room may refer to a logical server in the service management platform, and the users in the same platform virtual room may participate in the same activity only when all the users in the same platform virtual room need to log in the same logical server. The computer device may look for an idle logical server in the service management platform and create the platform virtual room based on that the idle logical server is found. If the platform virtual room is created successfully, the target objects (for example, the target objects may include the above first camp and the second camp) may be added into the platform virtual room, user states of the target objects are changed, and at the moment, the target objects may be informed of a message of being successfully added into the platform virtual room in the service management platform. If the platform virtual room is created unsuccessfully, error information is prompted in the service management platform, and the error information may be used for indicating the computer device to recreate a new platform virtual room.

Further, the computer device may perform initialization processing on the platform virtual room according to basic information (such as basic camp information of the first camp and the second camp, which may include the number of users contained in the two camps, the application corresponding to the participating activity, specific activity items and the like) of the target objects, and create the state machine capable of supporting service state switching for the platform virtual room in the service management platform, and at the moment, the state of the state machine may switch to a state of “waiting for a user to prepare”. The state machine may be configured to execute switching between service states of the target object in the application, and the application may be used for running the activity in which the target object participates. One or more applications may access the service management platform, the service management platform may manage activity competition services of these applications, the above application may be any one of the plurality of applications accessing the service management platform, the above one or more applications may access the service management platform in a platform united mode, competition services of the applications accessing the service management platform may be managed by the service management platform, and thus universality of the service management platform may be improved. In other words, in the service management platform, the activities in the different applications may be supported. For example: the application A, the application B and the application C may access the service management platform in a united mode, activity functions of the application A, the application B and the application C may be supported in the service management platform, for example, functions such as activity sign-up, team forming, grouping, competition creating, activity competition creating, competing result pull and activity progress push may be provided for the application A.

In some embodiments, when the user signing up successfully participates in the activity in a form of an individual, after the activity starts, each user participating in the activity may be called the target object in this embodiment of this application, and the computer device may create the platform virtual room for each user in the service management platform and create the state machine for each platform virtual room in the service management platform. In other words, the target object in the platform virtual room of the service management platform may be a single user, or a plurality of users as opponents against one another, or a single camp (one camp may include one or more users), or a plurality of camps as opponents against each other, or the like. For example: the target object may include M camps, and M may be a positive integer, for example, M may be a value of 1, 2, . . . For convenient description, description is made below by taking the target objects including the first camp and the second camp as opponents against each other as an example (that is, one camp may correspond to one opponent camp).

Step S102: Create a service virtual room in an application server of the application through the state machine, and add the target object into the service virtual room.

Specifically, after the target objects (the first camp and the second camp) are added into the platform virtual room, it means that the first camp and the second camp are about to start competing, at the moment, all the users of the first camp and the second camp need to make a preparation work, for example, checking whether devices used by themselves can work normally, whether a network connection is normal, and the like, or a before-activity preparation prompt may be shown to each user in the service management platform, and when the users finish a series of preparation operations according to the before-activity preparation prompt in the service management platform, the computer device may receive the preparation operations of the users and update current states of the users (for example, recording that the users have finished the preparation operations and the like). The computer device, when detecting that the users in the first camp and the second camp have finished the preparation operations, may drive the state machine to switch to a state of “create an activity room”, and the activity room here may be also called the service virtual room.

Further, the users in the first camp and the second camp may execute a trigger operation for a competition function in the service management platform, at the moment, the computer device may respond to the trigger operation of the users in the service management platform, the service virtual room is created in the application through a common protocol by the state machine in the service management platform, all the users contained in the first camp and the second camp are added into the service virtual room, and at the moment, the state of the state machine may switch to a state of “enter a service virtual room”. In other words, the users in the same platform virtual room in the service management platform may be added into the same service virtual room in the application through the state machine created in the service management platform.

In some embodiments, the first camp and the second camp in this embodiment of this application may be composed of the users participating in the competition, the users in the first camp and the second camp, after being added into the service virtual room, may select virtual persons in the application in the service management platform as characters participating in the competition, and the different users may select different virtual persons, or select the same virtual person, which is not limited in this application. The virtual persons selected by the users in the first camp in the application, skills the virtual persons possess and the like may constitute a first virtual person camp. The virtual persons selected by the users in the second camp in the application, skills the virtual persons possess and the like may constitute a second virtual person camp. Thus, the competition between the first camp and the second camp in the application may be essentially understood as a competition between the first virtual person camp and the second virtual person camp.

Step S103: Receive service progress data of the target object in the service virtual room through the state machine and drive the state machine to perform state updating to obtain a state-updated state machine.

Specifically, after the state machine switches to the state of “enter a service virtual room”, the computer device may receive service state change for the service virtual room in the application through the state machine, for example, the service progress data of the target objects (the first camp and the second camp) in the service virtual room, and the state of the state machine may be driven to switch, that is, state updating is performed on the state machine to obtain the state-updated state machine. The service progress data may refer to data for describing activity progress of the first camp and the second camp in the service virtual room, and the service progress data include but are not limited to: a service scenario of the service virtual room, the number of offline users, the number of online users, a competition parameter and the like in the first camp as well as the number of offline users, the number of online users, a competition parameter and the like in the second camp.

In order to guarantee that the competition between the first camp and the second camp in the platform virtual room of the service management platform may be pushed normally, data synchronization needs to be performed between the platform virtual room in the service management platform and the service virtual room in the application, and thus activity progresses between the platform virtual room and the service virtual room keep consistent. The state machine in this embodiment of this application may be configured to implement data synchronization between the platform virtual room and the service virtual room, and by switching the service states in the application, the activities in the service management platform may be automatically pushed. For example, when the first camp and the second camp start competing in the service virtual room, the state of the state machine may be updated according to competition start information of the service virtual room. When data such as changing a service scenario are generated in a competition process of the first camp and the second camp, the state of the state machine may be updated according to a changed service scenario in the service virtual room. When the current competition between the first camp and the second camp ends in the service virtual room, the state of the state machine may be updated according to competition end information of the service virtual room, and so on.

The service management platform may be configured to manage competition services of one or more applications, so a plurality of competitions may be performed in the service management platform at the same time, and these competitions may belong to the same application, or belong to the different applications, which is not limited in this application. Each competition in the service management platform is performed in an independent platform virtual room, one state machine may be created for each platform virtual room, the service virtual rooms are created in the corresponding applications through the corresponding state machines, that is, one platform virtual room corresponds to one state machine and one service virtual room, and data synchronization between each platform virtual room and the corresponding service virtual room is implemented through the state machine.

Step S104: Perform data synchronization processing on the platform virtual room according to the state-updated state machine and the service progress data of the service virtual room so as to synchronize object service information of the target object in the service virtual room into the platform virtual room.

Specifically, each state switching of the state machine may drive data changing of the platform virtual room of the service management platform so as to obtain activity progress of the target objects (the first camp and the second camp). For example, after the state of the state machine is updated, the computer device may perform data synchronization processing on the platform virtual room according to the state-updated state machine and the service progress data of the service virtual room to obtain the object service information of the first camp and the second camp in the service virtual room. The object service information may refer to competition data of the first camp and the second camp in the service virtual room, such as user real-time information in the two camps, real-time competition information between the two camps and the like.

Please refer to FIG. 4, FIG. 4 is a schematic structural diagram of a state machine provided by an embodiment of this application. As shown in FIG. 4, after the platform virtual room containing the first camp and the second camp is created in the service management platform, the state machine may be created for the platform virtual room in the service management platform. The computer device may perform initialization processing (such as initialization configuration) on the state machine through basic camp information corresponding to the first camp and the second camp. After initialization processing for the state machine is finished, the state machine may switch to a state of “waiting for start”, the state machine in the state of “waiting for start” may check an information flow in service processing, and after the information flow is checked with nothing wrong, the state of the state machine may switch to a state of “prepare” from the state of “waiting for start”. In the state machine, a next switchable state of the state of “prepare” is a state of “create a service virtual room”, when the state machine is in the state of “create a service virtual room”, if the computer device creates the service virtual room successfully in the application through the state machine, the state machine may switch to a state of “enter a service virtual room” from the state of “create a service virtual room”. If the computer device creates the service virtual room unsuccessfully in the application through the state machine, the state machine may switch to the state of “prepare” from the state of “create a service virtual room”.

When the state machine is in the state of “enter a service virtual room”, if the first camp and the second camp are successfully added into the service virtual room, the state of the state machine may switch to a state of “start an activity” from the state of “enter a service virtual room”. If the first camp and the second camp are added into the service virtual room unsuccessfully (for example, being canceled due to a fault of the service virtual room, or canceling the service virtual room due to users existing in the first camp and the second camp, or the like), the state machine may switch to the state of “create a service virtual room” from the state of “enter a service virtual room”. When the state machine is in the state of “start an activity”, it means that the first camp and the second camp have started competing in the service virtual room, when the competition ends, the state of the state machine may be driven to switch to a state of “read a competing result”, and the service management platform obtains the competing result (namely, an activity result) of the first camp and the second camp in the service virtual room through the state machine and may then show the competing result. In some embodiments, the first camp and the second camp may also continue to compete in next round in the service virtual room, for example, the first camp and the second camp may determine a final competing result between the two camps in a competition mode such as the best of three games or the best of five games, and at the moment, the state machine may switch to the state of “enter a service virtual room” again to start a new round of state switching.

In this embodiment of this application, the first camp and the second camp are distributed as opponent camps in the service management platform, the platform virtual room is created for the two camps, then the first camp and the second camp in the platform virtual room may be put in the same competition by creating the state machine, for example, the computer device may generate a competition mapping relationship in the application according to the platform virtual room in the service management platform, and through the competition mapping relationship, the first camp and the second camp in the service management platform may enter the service virtual room of the application through the service management platform. The above competition mapping relationship may refer to a mapping relationship between the platform virtual room in the service management platform and the service virtual room in the application, the competition mapping relationship may be executed after the service virtual room is created in the application, and mapping is performed according to states of the users in the first camp and the second camp in the application and states of the users in the service management platform.

Information synchronization in the application may be opened up through the state machine, state switching is performed on the state machine according to the service progress data of the first camp and the second camp in the application, and thus state push of the activity between the first camp and the second camp in the service management platform may be completed. In some embodiments, the competing result (namely, a camp competing result of the service virtual room) of the first camp and the second camp in the application is quite important to the service management platform, the competing result (also called the camp competing result or the object service information) of the first camp and the second camp in the service virtual room is obtained through the state machine, and the service management platform may calculate and judge a next step of state switching of the users in the first camp and the second camp in the service management platform based on the competing result, and may perform personalized adjustment for an activity rule of the application. Data synchronization between the service management platform and the application may be implemented through the state machine, the whole data synchronization process does not need manual intervention, and efficiency of data synchronization may be improved.

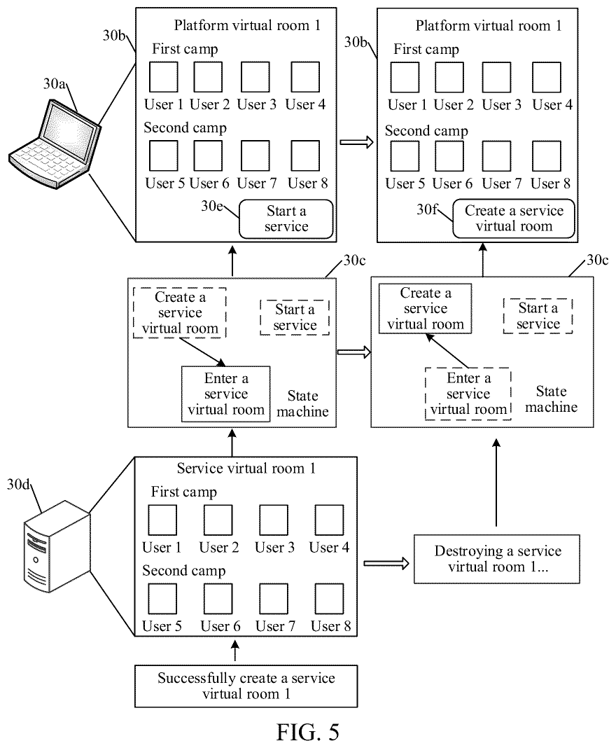

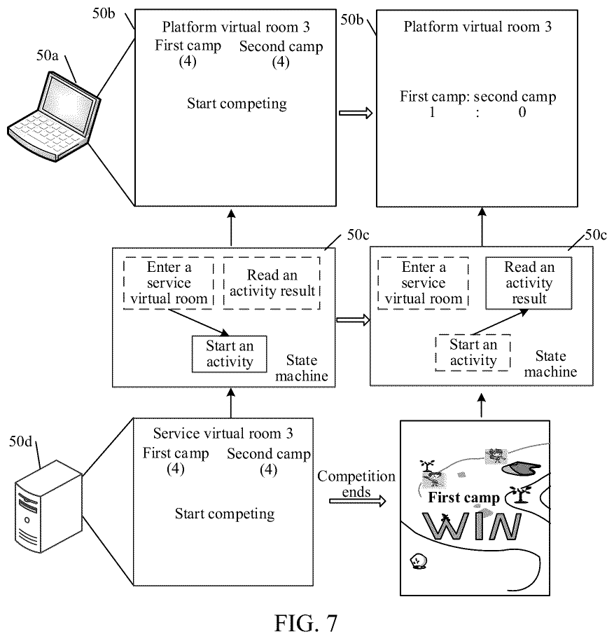

In some embodiments, the process of data synchronization between the service management platform and the application may be understood as a process of data synchronization between the platform virtual room in the service management platform and the service virtual room in the application. The process of data synchronization between the platform virtual room and the service virtual room will be described in detail below with reference to FIG. 5 and FIG. 7, which may be also understood as further description for above step S103 and step S104.

Please refer to FIG. 5, FIG. 5 is a schematic diagram of data synchronization processing between a platform virtual room and a service virtual room provided by an embodiment of this application. A user terminal 30a shown in FIG. 5 may be the computer device running the service management platform 30b, at the moment, the platform virtual room 1 is already created for the first camp and the second camp in the service management platform 30b (the target objects here include the first camp and the second camp), and the platform virtual room 1 contains all the users in the first camp and the second camp, such as the user 1, the user 2, the user 3 and the user 4 in the first camp as well as the user 5, the user 6, the user 7 and the user 8 in the second camp, that is, a platform competition is created for the first camp and the second camp in the service management platform 30b. After the platform virtual room 1 is created, the state machine 30c is also created for the platform virtual room 1 in the service management platform 30b.

After the user terminal 30a creates the service virtual room 1 in the application successfully through the state machine 30c, both the first camp and the second camp in the platform virtual room 1 may be added into the service virtual room 1, at the moment, the state of the state machine switches to the state of “enter a service virtual room”, for example, a server 30d shown in FIG. 5 may be a background server corresponding to the application, and the service virtual room 1 being created in the application successfully may be understood as being created in the server 30d successfully. According to the state of “enter a service virtual room” in the state machine 30c, the service management platform 30b may determine that the service virtual room (namely, the above service virtual room 1) corresponding to the platform virtual room 1 has been created successfully, and all the users in the first camp and the second camp are added into the service virtual room, data synchronization may be performed on the platform virtual room 1, for example, a “start a service” function 30e is added into the platform virtual room 1, and it may be also understood that at the moment, the first camp and the second camp in the platform virtual room 1 are in a state of “start a service”.

In some embodiments, when the service virtual room 1 in the application is destroyed, room destruction information corresponding to the service virtual room 1 containing the first camp and the second camp may be obtained, that is, at the moment, the service progress data of the first camp and the second camp in the service virtual room 1 are the room destruction information. State updating may be performed on the state machine according to the room destruction information, the state of the state-updated state machine is determined as a virtual room creating state (also called the state of “create a service virtual room”, that is, the state of the state machine 30c switches to the state of “create a service virtual room” from the state of “enter a service virtual room”), and the virtual room creating state is used for indicating to recreate a new service virtual room in the application. The user terminal 30a may perform data synchronization on the platform virtual room 1 according to the current state of “create a service virtual room” of the state machine 30c, for example, the “start a service” function 30e in the platform virtual room 1 is updated to a “create a service virtual room” function 30f.

It may be understood that after all the users of the first camp and the second camp are added into the service virtual room 1, state changing of the first camp and the second camp in the service virtual room 1 may switch the state of the state machine 30c, data updating may be performed on the platform virtual room 1 based on the state of the state machine 30c, and thus data of the platform virtual room 1 and the service virtual room 1 keep synchronous all the time.

In some embodiments, push of the activity progress needs to be guaranteed for the activity in the service management platform, in order to make the state of the state machine in the service management platform switch normally without blocking, the computer device (such as the above user terminal 30a) may set a duration threshold for each state of the state machine, and when times reaches the duration threshold, the service management platform may make a judgment according to current data of the platform virtual room 1 so as to push normal running of the activity. In some embodiments, the computer device may select key states from the state machine and set the duration threshold for each key state without setting the duration threshold for each state in the state machine, so that creating efficiency of the state machine may be improved. If a certain state in the state machine is blocked (for example, network delay, data interruption and the like) and consequently, the state machine cannot run normally despite any path, the state may be determined as the key state, these key states may be called baseline states in the state machine, the same duration threshold or different duration thresholds may be set for different key states, and a value of the duration threshold is not limited in this application. For example, when the updated state machine is in the virtual room creating state, the computer device may obtain duration information that the state of the state-updated state machine remains in the virtual room creating state, and when the duration information reaches the duration threshold, the state of the state-updated state machine may be updated to the preparing state from the virtual room creating state.

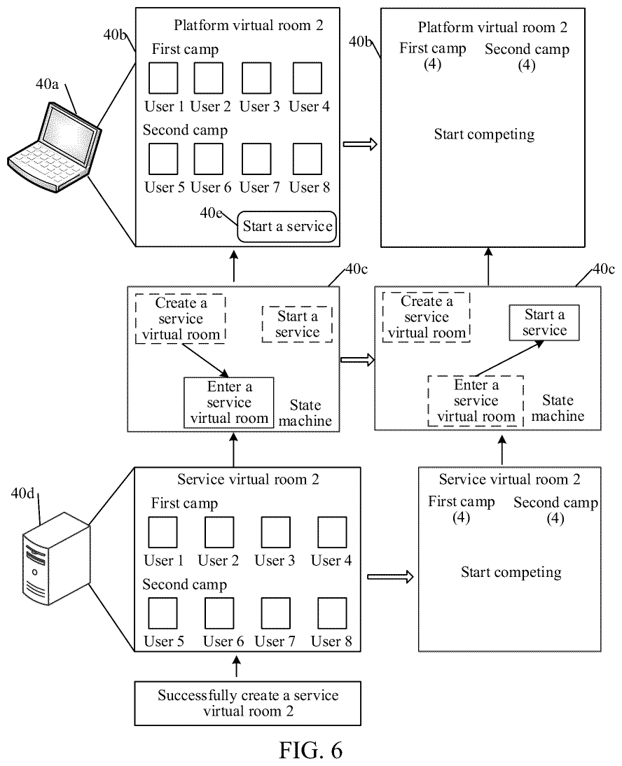

Please refer to FIG. 6, FIG. 6 is a schematic diagram of data synchronization processing between a platform virtual room and a service virtual room provided by an embodiment of this application. A user terminal 40a shown in FIG. 6 is the same as the user terminal 30a shown in FIG. 5, and a server 40d is the same as the server 30d shown in FIG. 5, which is not repeated in detail here.

After the user terminal 40a creates a service virtual room 2 in the application successfully through a state machine 40c, both the first camp and the second camp in a platform virtual room 2 may be added into the service virtual room 2, and at the moment, the state of the state machine switches to the state of “enter a service virtual room”. According to the state of “enter a service virtual room” in the state machine 40c, the service management platform 40b may determine that the service virtual room (namely, the above service virtual room 2) corresponding to the platform virtual room 2 has been created successfully, and all the users in the first camp and the second camp are added into the service virtual room, data synchronization may be performed on the platform virtual room 2, for example, a “start a service” function 40e is added into the platform virtual room 2, and it may be also understood that at the moment, the first camp and the second camp in the platform virtual room 2 are in a state of “start a service”.

In some embodiments, a service start state of the service virtual room 2 in the application is triggered, the user terminal 40a may obtain service start information of the first camp and the second camp in the service virtual room 2, that is, at the moment, the service progress data of the first camp and the second camp in the service virtual room 2 are the service start information. State updating is performed on the state machine according to the service start information, the state of the state-updated state machine is determined as a service started state (also called the state of “start a service”, that is, the state of the state machine 40c switches to the state of “start a service” from the state of “enter a service virtual room”), and the service started state is used for indicating the service management platform 40b to obtain the object service information of the first camp and the second camp in the service virtual room in a competition process. The user terminal 40a may perform data synchronization on the platform virtual room 2 according to the current state of “start a service” of the state machine 40c, for example, the object service information between the first camp and the second camp is shown in the platform virtual room 2, and the object service information shown in the platform virtual room 2 may keep synchronous with the object service information in the service virtual room 2.

Please refer to FIG. 7, FIG. 7 is a schematic diagram of data synchronization processing between a platform virtual room and a service virtual room provided by an embodiment of this application. States of a platform virtual room 3 and a service virtual room 3 shown in FIG. 7 are shown as FIG. 6, a user terminal 50a is the same as the user terminal 30a shown in FIG. 5, and a server 50d is the same as the server 30d shown in FIG. 5, which is not repeated in detail here. When a state of a state machine 50c is in the state of “start a service”, the service management platform 50b may implement data synchronization between the platform virtual room 3 and the service virtual room 3 through the state machine 50c, for example, object service information of the first camp and the second camp in the service virtual room 3 in a competition process is shown in real time in the platform virtual room 3. When an activity end state of the service virtual room 3 in the application is triggered, the user terminal 50a may obtain activity end information between the first camp and the second camp in the service virtual room, that is, at the moment, service progress data of the first camp and the second camp in the service virtual room 3 are the activity end information. Thus, state updating may be performed on the state machine according to the activity end information, a state of the state-updated state machine is determined as a result read state (also called a state of “read an activity result”, that is, the state of the state machine 50c switches to the state of “read a service result” from the state of “start a service”), the result read state is used for indicating the service management platform 50b to obtain the object service information of the first camp and the second camp in the service virtual room 3 when a competition ends, and at the moment, the object service information may be also called the camp competing result, or a service result or an activity result. The user terminal 50a may perform data synchronization on the platform virtual room 3 according to the current state of “read a service result” of the state machine 50c, for example, the camp competing result of the first camp and the second camp in the service virtual room 3 is shown in the platform virtual room 3, and if the camp competing result between the first camp and the second camp is 1:0, the first camp wins in this competition.

In this embodiment of this application, one or more applications may access the service platform data, when the first camp and the second camp match as competing camps, that is, when the platform virtual room is created, the objects in the first camp and the second camp may be added into the same service virtual room of the application through the state machine corresponding to the created platform virtual room, data synchronization between the platform virtual room and the service virtual room may be implemented through the state machine, and the synchronization processing process may avoid the tedious operation of manual typing in information and improve the efficiency of synchronization processing of the object service information.

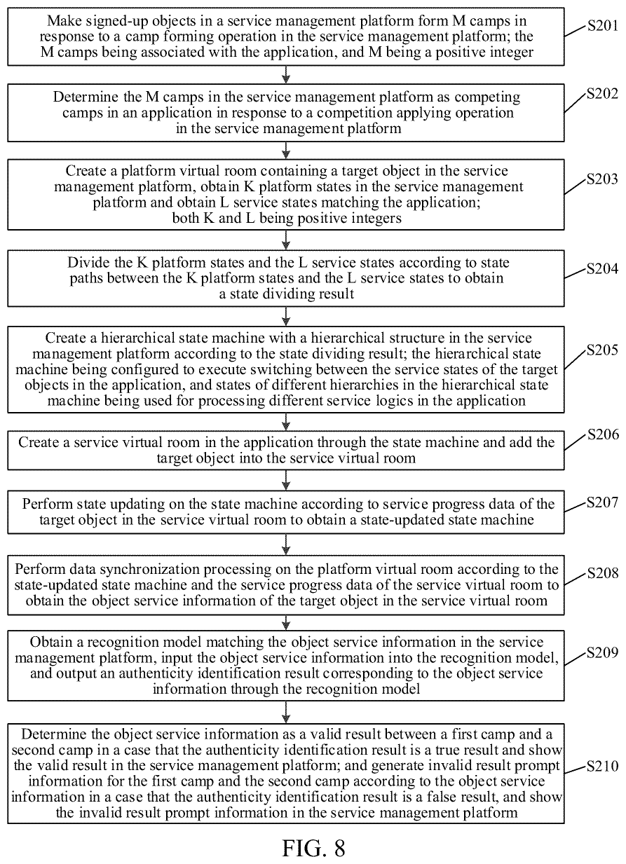

Please refer to FIG. 8, FIG. 8 is a schematic flowchart of a method for data synchronization provided by an embodiment of this application. It may be understood that the method for data synchronization may be executed by a computer device, and the computer device may be a user terminal or a server running the service management platform. As shown in FIG. 8, the method for data synchronization may include the following step S201 to step S210.

Step S201: Make signed-up objects in the service management platform form M camps in response to a camp forming operation in the service management platform; the M camps being associated with the application, and M being a positive integer.

In this embodiment of this application, a trigger operation for a camp forming function in the service management platform is jointly called the camp forming operation. The computer device may make the signed-up objects in the service management platform form the M camps in response to the camp forming operation in the service management platform, where M may be a positive integer. Each camp may include one or more signed-up objects, and the number of the signed-up objects in the camps signing up to participate in the same game event may be the same or not. It is to be understood that the service management platform may be configured to manage activities (such as competition services) of one or more applications , that is, different applications may access the service management platform, and the users may participate in activity sign-up, activity forming, activity competition and the like of the plurality of applications in the service management platform, the number of the signed-up objects in the camps signing up to participate in different activities may be the same or not, and the number of the signed-up objects contained in the camps may be determined according to an actual activity rule, which is not limited in this application.

A camp forming process is described in detail below by taking any one of the above M camps (such as an ith camp, and i is a positive integer smaller than or equal to M) as an example. The camp forming operation for a single camp in the service management platform may be called a forming sub-operation, for example, when the M camps are formed in the service management platform, the forming sub-operation is generated for at least M times in the service management platform, that is, the number of the forming sub-operations generated in the service management platform is greater than or equal to M (an invalid forming sub-operation may be generated in the service management platform, for example, the users in the same camp execute the forming sub-operation repeatedly, or the like), and all the forming sub-operations generated in the service management platform may be jointly called the camp forming operation. In other words, the above camp forming operation may include the forming sub-operations, and the computer device may obtain one or more signed-up objects determined by the forming sub-operation(s)in the service management platform in response to the forming sub-operation(s) in the service management platform. When the state(s) of the one or more signed-up objects in the management platform is/are a log-in state, the one or more signed-up objects form(s) the i^{th} camp. When a state of a signed-up object in the one or more signed-up objects in the service management platform is a not-log-in state, forming failure prompt information is generated in the service management platform, that is, camp forming fails this time, and the trigger operation needs to be executed for the camp forming function again.

Each camp in the service management platform may be formed according to the above operation, for example, the number of the formed camps in the service management platform is D, and D is a positive integer greater than or equal to M. All the D camps in the service management platform may be teams participating in the current application (the application is any one of the one or more applications accessing the service management platform), or the M camps in the D camps may be the teams participating in the current application, the remaining (D-M) camps may be the teams participating in other applications (other applications of the one or more applications accessing the service management platform except for the current application).

Step S202: Determine the M camps in the service management platform as competing camps in the application in response to a competition applying operation in the service management platform.

Specifically, after the signed-up objects in the service management platform form the M camps, each camp may select out a team leader, the team leader represents the entire camp to participate in the activity in a form of a camp, for example, the trigger operation (may be called the competition applying operation) is executed for an activity competition creating function in the service management platform, the computer device may determine the M camps in the service management platform as the competing camp in the application according to an activity rule in the service management platform in response to the competition applying operation in the service management platform, that is, the M camps are the opponent camps against each other, one camp may correspond to (M-1) camps, and at the moment, the M camps may be called the target objects.

When D camps participating in the application are formed in the service management platform, the computer device may perform competing camp matching on the D camps after responding to the competition applying operation in the service management platform, that is, each camp matches an opponent, M camps in the D camps are one group, and the M camps in each group may be called the target objects. For convenient description, description is made below by making M being a value of 2, that is, the target objects include the first camp and the second camp, and the first camp and the second camp match as the competing camps in the activity of the service management platform. Both the first camp and the second camp are camps signing up to participate in the activity of the application, that is, a most basic precondition of the first camp and the second camp matching as the competing camps is that the two camps participate in the same activity. Certainly, in an actual application scenario, other matching conditions may also be added, for example, a participating region and the like, which is not limited in this application.

Step S203: Create the platform virtual room containing the target object in the service management platform, obtain K platform states in the service management platform and obtain L service states matching the application. Both K and L are positive integers.

Specifically, when the first camp and the second camp in the service management platform are distributed as the competing camps, at the moment, the first camp and the second camp are called the target objects, and the computer device may create the platform virtual room for the first camp and the second camp in the service management platform, that is, an activity competition is created for the first camp and the second camp in the service management platform.

Further, as there are many applications accessing the service management platform, and service logics in all the applications are different, if the service states and states (may be called platform states) of the activity competition in each application are subdivided, the number of state paths to be managed by the service management platform will be huge. In this embodiment of this application, the computer device may obtain the K platform states for the above platform virtual room in the service management platform, at the same time, the L service states matching the application may be also obtained, where both K and L are positive integers, for example, K may be a value of 1, 2, . . . , L may also be a value of 1, 2, . . . , values of the K and L may be the same or not, and specific values may be determined according to actual conditions.

Step S204: Divide the K platform states and the L service states according to the state paths between the K platform states and the L service states to obtain a state dividing result.

Specifically, the computer device may divide the K platform states and the K service states to obtain the state dividing result. A basis of dividing the K platform states and the K service states may be the state path between the K platform states and the K service states, and state dividing is performed based on a state logic between each service state and each platform state so as to obtain the state dividing result.

Step S205: Create a hierarchical state machine with a hierarchical structure in the service management platform according to the state dividing result. The hierarchical state machine is configured to execute switching between the service states of the target objects in the application, and states of different hierarchies in the hierarchical state machine are used for processing different service logics in the application.

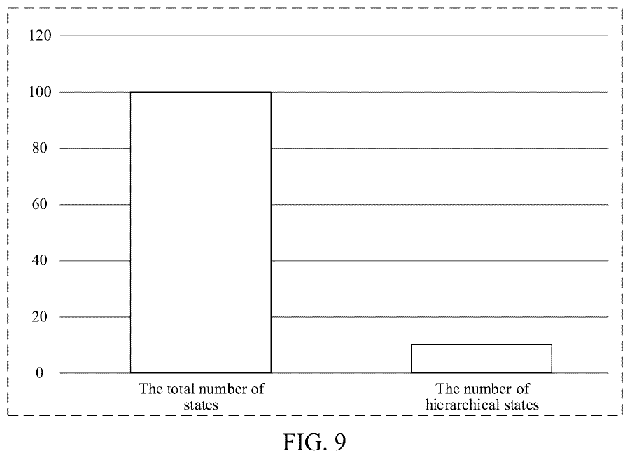

Specifically, the computer device may construct the state machine with the hierarchical structure, namely, the hierarchical state machine, for the platform virtual room in the service management platform according to the state dividing result, state contraction may be completed through the state machine with the hierarchical structure, and thus corresponding sub-states may be processed respectively through each hierarchy of state machine. The state machine may support switching between the service states in the application, and different hierarchies of states in the hierarchical state machine may be used for processing the different service logics in the application. After the state machine is hierarchically divided, the number of the states in the platform virtual room is greatly reduced. Please refer to FIG. 9, FIG. 9 is a schematic diagram of the number of states of a hierarchical state machine provided by an embodiment of this application. As shown in FIG. 9, before hierarchical dividing, it is assumed that the total number of states is 100, after hierarchical dividing, the number of hierarchical states of the state machine corresponding to the platform virtual room may be a value smaller than 10. For example, the state machine corresponding to the platform virtual room in the service management platform may include the following several states: waiting for start, having started and waiting for a user to prepare, having prepared and waiting for a user to create a room, having created a room and waiting for a user to enter the room, having started a competition, having obtained a result and being obtaining a competing result detail. The above several states may be called baseline states in the service management platform, and the state machine may switch between the above several baseline states.

The service logics in the application (for example, as for a game application, the service logic may be specifically a game logic) may be developed on the above baseline states respectively, and the corresponding service logics are implemented in the different hierarchical states. In order to drive state switching of the state machine, an event processing module may be introduced in the service management platform, and the event processing module may be configured to be responsible for event accessing in the application. For example, normal switching of the whole state machine may be driven by implementing the following several states in the application, and these states may include: service virtual room person change, service virtual room destruction, competition start and competition end. Data of the application may be recorded in real time, but some data do not affect state switching of the state machine, and the latest state of the competition may be maintained in real time by the service management platform. Meanwhile, real-time detection may be performed in the hierarchical states, and processing is performed for different events and service logics in the different states. The hierarchical states need corresponding state hierarchies respectively to process the corresponding events and complete event distribution, and afterwards, state switching of a next hierarchy is determined by the corresponding service state hierarchy.

The corresponding baseline states of the state machine and the service states of the application accessing the service management platform are only examples, and the specific state types and the specific number of states may be adjusted according to actual demands, which is not limited in this application.

Step S206: Create the service virtual room in the application through the state machine and add the target object into the service virtual room.

Step S207: Perform state updating on the state machine according to the service progress data of the target object in the service virtual room to obtain the state-updated state machine.

Step S208: Perform data synchronization processing on the platform virtual room according to the state-updated state machine and the service progress data of the service virtual room to obtain the object service information of the target object in the service virtual room.

In this embodiment of this application, description is made by taking the target objects including the first camp and the second camp as an example. Specific implementation processes of step S206 to step S208 may refer to the descriptions of step S102 to step S104 in the corresponding embodiment in FIG. 3 as well as the corresponding embodiment in FIG. 5 to FIG. 7, which is not repeated in detail here.

Step S209: Obtain a recognition model matching the object service information in the service management platform, input the object service information into the recognition model, and output an authenticity identification result corresponding to the object service information through the recognition model.

Specifically, in order to prevent the users from using a pinch hitter in the competition, or using an illegal device for pinch hitting, the computer device may use the recognition model to perform pinch hitting preventing detection after obtaining the object service information (at the moment, the object service information may be the camp competition information) of the target objects (the first camp and the second camp), for example, the recognition model matching the object service information may be obtained in the service management platform, the object service information is inputted into the recognition model, and the authenticity identification result corresponding to the object service information is outputted through the recognition model. The recognition model may be a neural network model, or a convolutional neural network model, a structure and a type of the recognition model are not limited in this application, and the recognition model is formed by being trained through sample data extracted from the state machine.

In some embodiments, the service management platform may include one or more recognition models, and as for the above object service information, the computer device may select one or more recognition models from the service management platform to perform the pinch hitting preventing detection on the object service information. In other words, the number of the recognition models may be N, and N is a positive integer. The computer device may obtain a recognition model set from the service management platform and determine N recognition models matching the object service information from the recognition model set according to weight information and a model type corresponding to each recognition model in the recognition model set; and input the object service information into the N recognition models respectively, output N recognition results corresponding to the object service information through the N recognition models and determine the authenticity identification result corresponding to the object service information according to the N recognition results. The authenticity identification result may be a pinch hitting detection result corresponding to each user in the first camp and the second camp, that is, whether each user in the first camp and the second camp uses the pinch hitter may be determined through the recognition model, the authenticity identification result corresponding to the above object service information may be judged to be a false result as long as there is a user using the pinch hitter, and the authenticity identification result corresponding to the above object service information may be judged to be a true result as long as there is no user using the pinch hitter in the two camps.

In some embodiments, the process of determining the authenticity identification result of the object service information based on the N recognition results described above may include: the computer device may determine that the authenticity identification result corresponding to the object service information is the true result when a proportion that the number of true results in the N recognition results judged by the recognition model accounts for of the N recognition results is greater than a proportion threshold (the proportion threshold may be set according to actual demands, for example, the proportion threshold may be set to be 60% and the like); and may determine that the authenticity identification result corresponding to the object service information is the false result when the proportion is smaller than or equal to the proportion threshold, that is, there may be pinch hitting behaviors in the first camp and the second camp. For example, the N recognition models include the recognition model A, the recognition model B and the recognition model C; the recognition result obtained after performing pinch hitting preventing detection on the object service information by the recognition model A is the true result, that is, the recognition model A judges that the object service information is the true result; the recognition result obtained after performing pinch hitting preventing detection on the object service information by the recognition model B is the false result, that is, the recognition model B judges that the object service information is a pinch hitting result; and the recognition result obtained after performing pinch hitting preventing detection on the object service information by the recognition model C is the true result, that is, the recognition model C judges that the object service information is the true result. The number of the true results contained in the N recognition results (at the moment, N takes a value of 3) is 2, the number of the false result is 1, the proportion of the number of the true results to the N recognition results is ⅔, and it is assumed that the proportion threshold is set to be 60%, the authenticity identification result corresponding to the object service information may be determined as the true result.

In some embodiments, a manual intervention means may be further introduced into the above process of determining the authenticity identification result of the object service information based on the N recognition results, and when all the N recognition results are the true results, the authenticity identification result of the object service information may be directly determined as the true result; and when there is the false result in the N recognition results, the object service information is submitted to a manual check process in the service management platform, and the authenticity identification result corresponding to the object service information is determined by manual intervention. The N recognition models are selected out of the recognition model set as pinch hitting preventing detection models, and detection accuracy of the object service information may be improved on the premise of guaranteeing detection efficiency of the object service information.

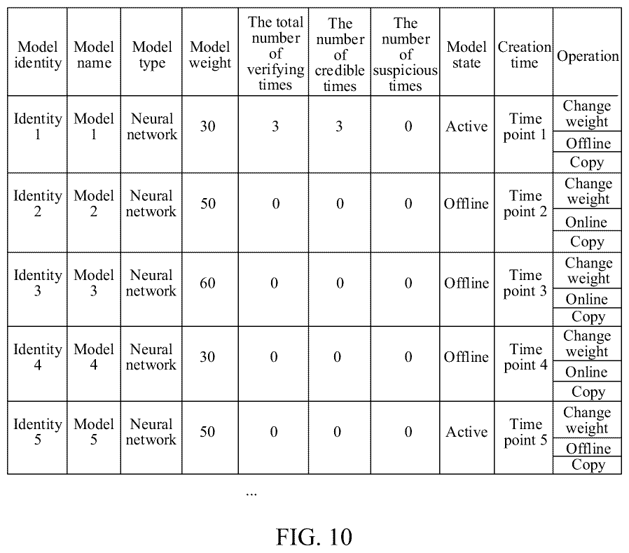

Please refer to FIG. 10, FIG. 10 is a schematic diagram of selection of a recognition model provided by an embodiment of this application. As shown in FIG. 10, the recognition model set of the service management platform may include a plurality of recognition models such as the model 1 to the model 5, each recognition model may have a different network structure, each model corresponds to a unique model identity, a model name and a model weight (namely, the above weight information), the number of times of using each recognition model for detecting the object service information is recorded, and the number of credible detection results, the number of suspicious detection results and creation time of the recognition model may be recorded. As shown in FIG. 10, in a pinch hitting preventing detection process of the object service information this time, the computer device selects the model 1 and the model 5 in the service management platform as the recognition models based on an application type corresponding to the application and a model weight corresponding to each recognition model, at the moment, model states of the model 1 and the model 5 are “active”, model states of the other models are “offline”, the model 1 and the model 5 in the state of “active” may perform pinch hitting preventing detection on the object service information, and the models in the state of “offline” cannot perform pinch hitting preventing detection on the object service information.

In some embodiments, each recognition model in the recognition model set in the service management platform may have a corresponding operation control, such as a “weight change” control, an “offline” control, a “copy” control and an “online” control, and when the models (such as the model 1 and the model 5) are in the state of “active”, the operation controls corresponding to the models may include the “weight change” control, the “offline” control and the “copy” control. When the models (such as the model 2, the model 3 and the model 4) are in the state of “offline” state, the operation controls corresponding to the models may include the “weight change” control, the “online” control and the “copy” control. When the user executes the trigger operation for the “weight change” control of the model 1 and changes the model weight of the model 1 to 40, the computer device may update the corresponding model weight of the model 1 to 40 in response to the trigger operation. When the user executes the trigger operation for the “online” control of the model 3, the computer device may update the corresponding model state of the model 1 to the state of “active” in response to the trigger operation. The “copy” control may be configured to copy related information of the current recognition model.

Step S210: Determine the object service information as a valid result between the first camp and the second camp when the authenticity identification result is a true result and show the valid result in the service management platform; and generate invalid result prompt information for the first camp and the second camp according to the object service information when the authenticity identification result is a false result, and show the invalid result prompt information in the service management platform.

Specifically, after obtaining the authenticity identification result corresponding to the object service information, when the authenticity identification result is the true result, it means that there is no user using the pinch hitter in the first camp and the second camp, that is, the competing result is obtained by their own strengths, the object service information may be determined as the valid result between the first camp and the second camp, and the valid result is shown in the service management platform. When the authenticity identification result is the false result, it means that there is a user using the pinch hitter in the first camp and the second camp, the object service information is canceled this time, and the invalid result prompt information for the first camp and the second camp is generated according to the object service information and shown in the service management platform.

Before the recognition model in the above recognition model set is used, model training needs to be performed, the recognition models in the recognition model set may adopt the same sample data for centralized training, and description is made below by taking a training process of any one recognition model in the recognition model set as an example. The computer device may obtain sample data (also called sample competition data) in a sample room in the application and label the sample data to obtain label information corresponding to the sample data, for example, the sample data are labeled as positive and negative samples, a positive sample is true sample data of the user, and a negative sample is sample data generated by pinch hitting. Thus, the sample data may be inputted into an initial recognition model, a predictive identification result corresponding to the sample data is outputted through the initial recognition model, a network parameter of the initial recognition model is revised according to the label information and the predictive identification result to generate a trained recognition model, and the recognition model is issued in the service management platform.

After obtaining the predictive identification result corresponding to the sample data, the computer device may obtain a predictive distance between the label information and the predictive identification result, a loss function corresponding to the initial recognition model may be determined according to the predictive distance, the network parameter of the initial recognition model is revised by performing optimizing processing on the loss function, and the initial recognition model containing the revised network parameter is determined as a target recognition model. The label information may be regarded as an expected detection result corresponding to the sample data, the predictive identification result is an actual detection result obtained by detection of the initial recognition model, the above predictive distance may be regarded as a difference between the actual detection result and the expected detection result, the predictive distance may be an Euclidean distance, a Manhattan distance, a Chebyshev distance, a Minkowski distance, a Mahalanobis distance and the like, and a computing mode of the predictive distance is not limited in this application. In some embodiments, the loss function of the initial recognition model may also be other forms, such as a square loss function and an exponential loss function, and the loss function of the initial recognition model is not limited in this application.

In one or more embodiments, description is made by taking the Euclidean distance as an example. The training process of the recognition model may be performed in TensorFlow (an end-to-end open-source machine learning platform), and certainly may further be trained in other machine learning platforms, which is not limited in this application. The Euclidean distance between the label information and the predictive identification result may be used as the loss function of the initial recognition model, and a computing mode of performing backpropagation on the initial recognition model based on the loss function determined by the Euclidean distance may be shown in the following formula (1):

$${δ}_{j}^{( n )} = \frac{\partial {C}^{*} ( X )}{\partial {u}_{j}^{( n )}} = \frac{\partial C ( Y , {v}_{j}^{( n )} )}{\partial {u}_{j}^{( n )}} = \frac{\partial C ( Y , {v}_{j}^{( n )} )}{\partial {v}_{j}^{( n )}} \cdot \frac{\partial {v}_{j}^{( n )}}{\partial {u}_{j}^{( n )}} = \frac{\partial C ( Y , {v}_{j}^{( n )} )}{\partial {v}_{j}^{( n )}} \cdot {φ}^{′} ( {u}_{j}^{( n )} ) \qquad ( 1 )$$

where, δⱼ⁽ⁿ⁾ may be represented as a loss function of a j^{th} recognition model, the sample data may be represented as (X,Y), X is the sample data per se, Y is the label information corresponding to the sample data, and uⱼ⁽ⁿ⁾ and vⱼ⁽ⁿ⁾ may be represented as the predictive identification result outputted by an nth network layer of the i^{th} recognition model.

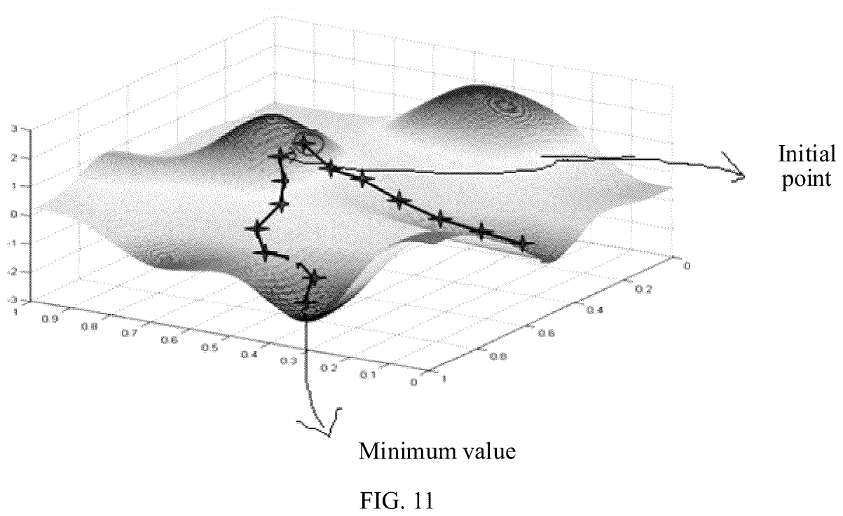

Please refer to FIG. 11, FIG. 11 is a schematic diagram of gradient descent provided by an embodiment of this application. For better fitting according to the sample data, rapid settlement processing may be performed while the gradient descent is executed, and random gradient descent is executed. When the random gradient descent is executed, it may be in any random position at the beginning, such as an initial point shown in FIG. 11, iterative computation is performed every time in a direction of greatest descent, in this way, a speed of finding out a minimum value is the highest, and a random gradient descent process may be understood as a process of finding out the minimum value.

In one or more embodiments, the initial recognition model may include an input layer, an output layer and a plurality of hidden layers (such as 3), an activation function (such as a sigmoid function) may further be introduced into the initial recognition model, so that the initial recognition model may support pinch hitting categories in a nonlinear state, and the sigmoid function may be shown in the following formula (2):

$$sigmoid ( x ) = \frac{1}{1 + {e}^{- x}} \qquad ( 2 )$$

Through processing of the activation function, the trained recognition model may accurately process a nonlinear problem, and in a case of meeting nonlinearity, the trained recognition model still has very strong pinch hitting preventing detection capability.

In some embodiments, the sample data for training the initial recognition model may include competition data of opponents, competition data of teammates, historical data of the teammates, historical data of the opponents and the like, a coverage range of the model inputted data is widened, and cheating difficulty in the competing process is increased for the user. After obtaining the target recognition model through training and the computer device obtains the object service information from the service virtual room of the application subsequently, the object service information may be inputted into the recognition model, forward calculation is performed through the recognition model, a detection result of the object service information may be obtained, or the detection result may be regarded as a pinch hitting detection result corresponding to each user in competition, and accuracy of pinch hitting preventing detection may be improved.

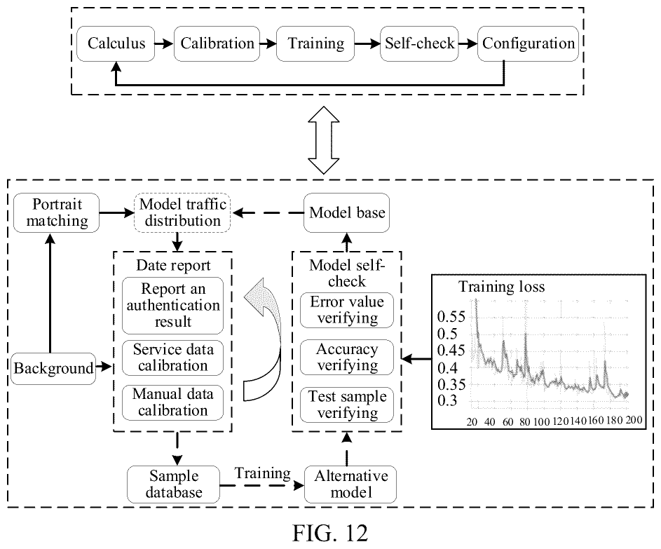

Please refer to FIG. 12, FIG. 12 is a schematic diagram of training of a recognition model provided by an embodiment of this application. As shown in FIG. 12, the training process of the recognition model may include calculus, calibration, training, self-check and configuration processes. In the service management platform, competition data (also called game data) generated by each competition may be used as the sample data, the sample data are labeled as the positive and negative samples, and the sample data labeled as the positive and negative samples (namely, marked with the label information) are added into a sample database. The initial recognition model is trained by using the sample data in the sample database, that is, the sample data are inputted into the initial recognition model (also called an alternative model), and forward calculation (calculus) is performed on the sample data in the initial recognition model to obtain the predictive identification result of the sample data. The network parameter of the initial recognition model is trained through the predictive distance between the predictive identification result and the label information, after training is completed, model self-check may be further performed on the initial recognition model whose training is completed, such as error value verifying, accuracy verifying and test sample verifying. The initial recognition model whose training is completed may be improved through model self-check to obtain a finally trained recognition model, the recognition model is added into a model base (such as the above recognition model set), and the recognition model may be issued in the service management platform.

The recognition model in the model base may be configured to execute pinch hitting preventing detection, each recognition model added into the model base may undertake a part of pinch hitting preventing detection tasks in the service management platform. The service management platform, after pulling the object service information from the service virtual room, may perform portrait matching on the user in the service virtual room, find out the recognition model matching the object service information from the model base and perform model traffic distribution for the recognition model, that is, a detection task is configured for the recognition model. The recognition model may report the authenticity identification result (also called an authentication result) of the object service information to the service management platform, and the service management platform may add the reported authenticity identification result into the sample database. In some embodiments, operations such as service data calibration and manual data calibration may be further executed for the obtained sample data, the calibrated data are added into the sample database, in this way, the sample database may be updated continuously, and the updated sample database is more beneficial for training a better recognition model. When an authenticity identification result obtained after executing the operations such as the service data calibration and the manual data calibration is inconsistent with the authenticity identification result outputted by the recognition model, the above-mentioned authenticity identification result outputted by the recognition model may be updated, and after adding the updated authenticity identification result into the sample database, the updated sample database may be obtained. The above operations such as portrait matching of the user, service data calibration, manual data calibration and reporting of the authenticity identification result may be executed by a background, the background here may be also called a special permission background, and the special permission background may refer to a background with permissions such as user portrait matching, service data calibration, manual data calibration and authenticity identification result reporting.

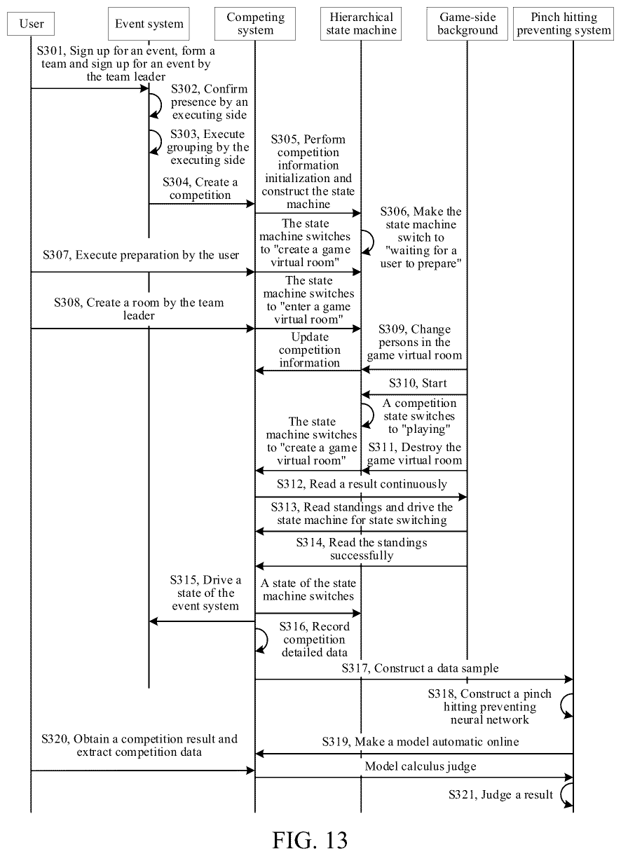

Please refer to FIG. 13, FIG. 13 is a schematic sequence chart of synchronization of object service information in a service management platform provided by an embodiment of this application. As shown in FIG. 13, taking the service management platform being the multi-game-event platform as an example, a service processing flow in the service management platform is described, and the multi-game-event platform may be an event system capable of providing capability of whole-process automated pushing of a competition schedule. The service processing flow in the service management platform may be achieved through a competition among the event system, the competing system, the hierarchical state machine, the game-side background and a pinch hitting preventing system. The event system and the competing system may be systems with different functions or may be also combined as the same system. The hierarchical state machine may be one component in the competing system or the event system, that is, one hierarchical state machine may be constructed in the competing system or the event system. The pinch hitting preventing system may be a system independent of the competing system or the event system, or may also be one component in the competing system or the event system. Architecture composition among the event system, the competing system, the hierarchical state machine and the pinch hitting preventing system is not limited in this application. The game-side background may be a background server corresponding to the game application, and the event system or the competing system in this application is independent of the game application. The service processing flow in the service management platform may include the following step S301 to step S321.

S301: Sign up for an event, form a team (camp) and sign up for an event by the team leader. A single user may log in an event sign-up activity in the event system and fill the event system with participating information to complete individual sign-up. The user may also form a team in the event system, when the number of participating members in the team reaches the number of members required by a game event, it means that the user completes forming of the team, that is, one team may be composed of one or more users. When the number of participating members in one team is smaller than the number of the members required by the game event, the team cannot be formed successfully. One participating member may be selected out of a successfully formed team as the team leader, the team leader may sign up for the game event on behalf of the entire team, that is, in the game event, the users participate in the game event in a form of a team.

It may be understood that the game event in the event system may include events for different games, therefore, different teams may select one game event to sign up according to their own conditions, that is, the different teams may sign up for the same game event in the event system, or may also sign up for different game events in the event system, which is not limited in this application.

S302: Confirm presence by an executing side. After the team leader completes team sign-up in the event system, the event system may select to open the game event and completes confirmation of all name lists participating in the game event, for example, whether members in the team signing up to participate in the game event are present is detected, and “presence” here may be understood as that a state of account information of the user in the event system is a state of having logged in. If there is a member being absent in a certain team, it may be determined that the team cannot participate in the subsequent game event, which is regarded as voluntary waiver. If all the members in the team are present, it is determined that the team may participate in the game event normally.

S303: Execute grouping by the executing side. A system completes opponent matching of each team. The executing side here may refer to the computer device running the service management platform, and the computer device may divide the teams successfully signing up for the game event into groups in an event rule in the event system to complete opponent matching of each team, that is, a competing camp is distributed for each team.

S304: Create a competition. The computer device confirms that the teams against each other start competing, the event system may create the competition for two teams (such as the above first camp and the second camp, namely, the target objects) in the competing system, that is, the platform virtual room is created.

S305: Perform competition information initialization and construct the state machine. The competing system may perform information initialization processing on the platform virtual room and construct the state machine which supports game state switching.

S306: Make the state machine switch to “waiting for a user to prepare”. After the state machine is created, the state of the state machine automatically switches to the state of “waiting for a user to prepare”.

S307: Execute preparation by the user. The competing system receives a preparation operation of the user, and after the users in the two teams finish preparation, the state machine is driven to switch to the state of “create a game virtual room”.

S308: Create a room by the team leader. Through clicking trigger by the user, the state machine may create the game virtual room in a target game application through a common protocol, and after the room is created successfully, the state machine is driven to switch to the state of “enter a game virtual room”.

S309: Change persons in the game room. When the state machine is in the state of “enter a game virtual room”, the state machine may receive call-back of change of a state of the game virtual room in a target game application, and real-time synchronization of user information in the platform virtual room is performed.

S310: Start. After the game virtual room in the target game application triggers a state of game start (namely, game start information), the state machine may be driven to switch to the state of “playing”.

S311: Destroy the game room. If the game virtual room does not trigger the game start information but triggers a room destruction signal, at the moment, the state machine may switch to the state of “create a game virtual room”.

S312: Read a result continuously. After the state machine is in the state of “playing”, the competing system reads a game competing result in the game virtual room continuously.

S313: Read standings and drive the state machine for state switching. After the game virtual room in the target game application triggers a “game over” signal (namely, game over information), the state of the state machine may switch to the state of “read standings” (also called a state of “read a competing result”).

S314: Read the standings successfully. When the competing system reads the competing result in the game virtual room, a user result is recorded, the state machine is driven to switch to the competition over state, and a result is transferred.

S315: Drive the state of the event system. The event system pushes a process of the event system according to the competing result in the game virtual room, completes switching of the event state and achieves automatic running to the greatest extent.

S316: Record competition detailed data. After camp competition data corresponding to the two teams are obtained, the competing system may record the competition detailed data of the user, including used devices, characters, killing, secondary attack and other data as well as data of teammates and opponents.

S317: Construct a data sample. The competing system may store the recorded data in the sample database.

S318: Construct a pinch hitting preventing neural network (also called the recognition model), use data in the sample database as an input of the pinch hitting preventing neural network and use a label of whether it is pinch hitting as an output of the pinch hitting preventing neural network for training.

S319: Make a model automatic online. After the pinch hitting preventing neural network is trained, that is, the recognition model is obtained by training, the recognition model may be automatically online in the event system. Step S317 to step S319 are specific to a training process of the pinch hitting preventing neural network, the neural network may be pre-trained before being used for performing pinch hitting preventing detection, and the neural network whose training is completed may be used for performing pinch hitting preventing detection after being online.

S320: Obtain a competition result and extract competition data. When the user participates in the game competition subsequently, the camp competition information (namely, the above object game information) in the game competition may be obtained.

S321: Judge a result. The camp competition information is inputted into the trained neural network for calculation, whether the users in the two teams use the pinch hitter is judged, a pinch hitting judgment is executed, and then an authenticity identification result of the camp competition information is obtained.

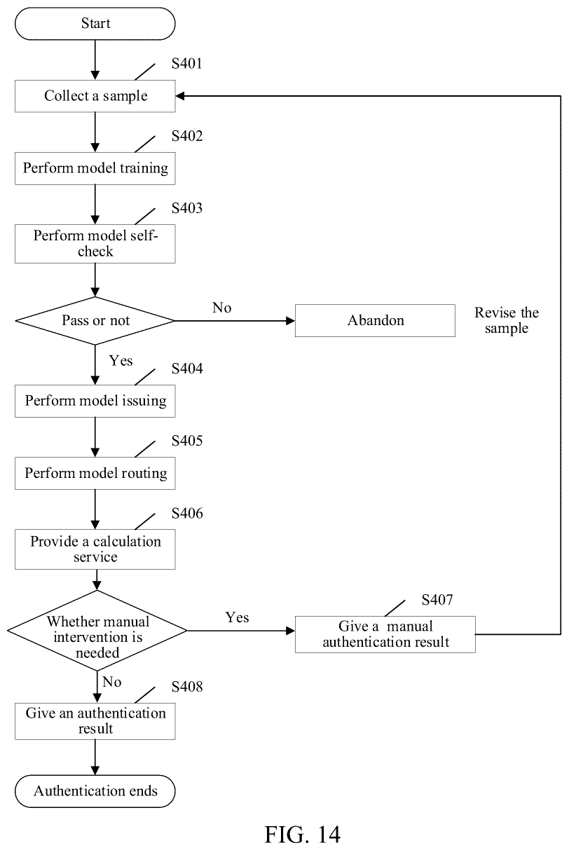

Please refer to FIG. 14, FIG. 14 is a schematic flowchart of management of a recognition model in a service management platform provided by an embodiment of this application. In order to guarantee that the service management platform may safely and stably switch in the different recognition models, the service management platform may have functions such as verifying, management, issuing, data collection and routing, so as to achieve effective management and safe switching of each recognition model. As shown in FIG. 14, a management flow of a network model may be implemented through step S401 to step S408.

S401: Collect a sample. The computer device may collect the sample data, label the sample data as the positive and negative samples and add the labeled sample data into the sample database.

S402: Perform model training. The initial recognition model is trained through the collected sample data of the sample database and the label information thereof, and a specific training implementation process may refer to S210 in FIG. 8 and will not be repeated in detail here.

S403: Perform model self-check. The model self-check may include error value verifying, accuracy verifying, test sample verifying and the like, and if it passes the model self-check, subsequent step S404 continues to be executed. If it does not pass the model self-check, the recognition model is abandoned. Pinch hitting preventing detection capability of the recognition model may be improved through the model self-check.

S404: Perform model issuing. The recognition model which is subjected to the model self-check may be automatically issued on the service management platform, for example, automatically online in the service management platform.

S405: Perform model routing. Model routing is a main module to guarantee that the service management platform runs stably, and online pinch hitting preventing detection capability can be adjusted dynamically. Model routing may refer to selection of the recognition model, for example, a target recognition model matching the object game information is found from the recognition model set, and a determining process of the target recognition model is determined by model routing.

S406: Provide a calculation service. After the target recognition model is determined through model routing, the authenticity identification result of the object game information is outputted through the calculation service provided by the target recognition model. Thus, whether manual intervention needs to be performed may be determined according to the authenticity identification result outputted by the target recognition model, and if manual intervention is needed, step S407 continues to be executed. If no manual intervention is needed, step S408 continues to be executed.

S407: Give a manual authentication result. When manual intervention is needed, the final manual authentication result, or called a manual identification result, is given through manual check, and the manual authentication result may be used for revising the sample data in the sample database.

S408: Give the authentication result. When no manual intervention is needed, the final authentication result is given through the authenticity identification result outputted by the target recognition model.

The different recognition models may have different pinch hitting preventing detection capabilities, these recognition models may be managed in a united mode in the service management platform, and by continuously adjusting the model weights corresponding to the recognition models respectively, the service management platform may achieve capability of dynamically adjusting a recognition characteristic of the online recognition model. Meanwhile, when a new recognition model is issued in the service management platform, roll-back of the service management platform may be achieved at some necessary moments, so the online service management platform is upgraded seamlessly with safety guarantee, upgrading efficiency of the service management platform may be improved, and the universality of the service management platform is improved.

In some embodiments, the recognition model set in this application may belong to the service management platform, and all the recognition models in the recognition model set may be managed by the service management platform. Or, the recognition models may be stored in a model management system outside the service management platform, that is, the service management platform may have a permission of using the recognition models but does not have a permission of managing the recognition models, and the recognition models in the recognition model set are managed by the model management system.

When the computer device in this embodiment of this application obtains personal sign-up information of the user, camp competition information (namely, the object service information), activity progress information and other data, a prompt interface or a pop-up window may be displayed, the prompt interface or the pop-up window is used for prompting the user that the personal sign-up information, or the camp competition information, or the activity progress information and other data are being collected at present, related steps of data obtaining start to be executed only after obtaining a confirmation operation for the prompt interface or the pop-up window performed by the user, and otherwise, it ends.

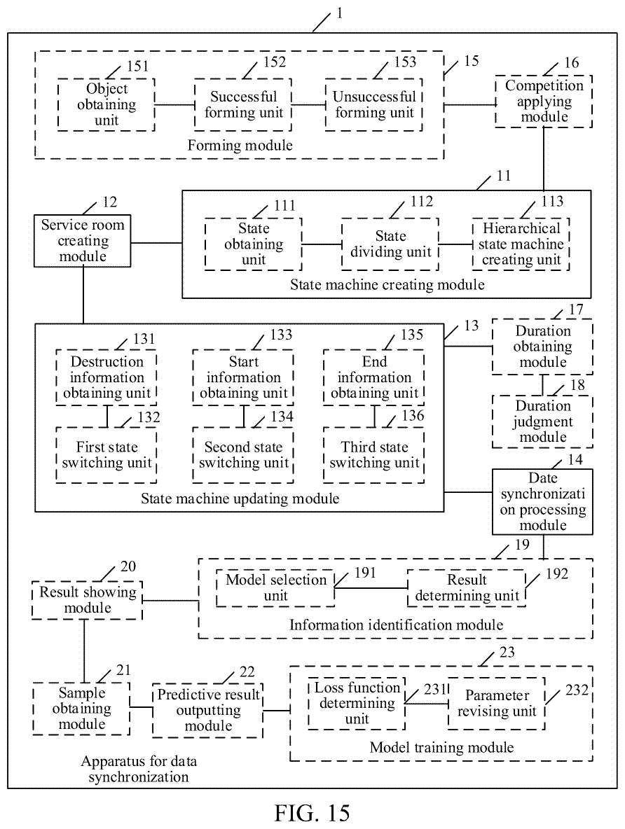

Please refer to FIG. 15, FIG. 15 is a schematic structural diagram of an apparatus for data synchronization provided by an embodiment of this application. As shown in FIG. 15, the apparatus 1 for data synchronization may include: a state machine creating module 11, a service room creating module 12, a state machine updating module 13 and a data synchronization processing module 14.

The state machine creating module 11 is configured to create a platform virtual room containing a target object in a service management platform, and create a state machine for the platform virtual room; the state machine being configured to execute switching between service states of the target object in an application; and the application being one of a plurality of applications accessing the service management platform.

The service room creating module 12 is configured to create a service virtual room in an application server of the application through the state machine, and add the target object into the service virtual room.

The state machine updating module 13 is configured to receive service progress data of the target object in the service virtual room through the state machine and drive the state machine to perform state updating to obtain a state-updated state machine.

The data synchronization processing module 14 is configured to perform data synchronization processing on the platform virtual room according to the state-updated state machine and the service progress data of the service virtual room so as to synchronize object service information of the target object in the service virtual room into the platform virtual room.

Specific function implementation modes of the state machine creating module 11, the service room creating module 12, the state machine updating module 13 and the data synchronization processing module 14 may refer to step S101 to step S104 in the corresponding embodiments in FIG. 3 and will not be repeated in detail here.

In one or more embodiments, the above target object includes M user groups (or camps), M is a positive integer, and the apparatus 1 for data synchronization may further include: a forming module 15 and a competition applying module 16.

The forming module 15 is configured to make signed-up objects in the service management platform form M user groups in response to a user group forming operation in the service management platform; the M user groups being associated with the application.

The competition applying module 16 is configured to determine the M user groups in the service management platform as competing user groups in the application in response to a competition applying operation in the service management platform.

In some embodiments, the forming operation includes forming sub-operations.

The forming module 15 includes: an object obtaining unit 151, a successful forming unit 152 and an unsuccessful forming unit 153.

The object obtaining unit 151 is configured to obtain one or a plurality of objects determined by the forming sub-operation in the service management platform in response to the forming sub-operation in the service management platform.

The successful forming unit 152 is configured to make the one or plurality of objects form an ith user group when all states of the one or plurality of objects in the management platform are a state of having logged in. An ith camp belongs to the M user groups, and i is a positive integer smaller than or equal to M.

The unsuccessful forming unit 153 is configured to generate forming failure prompt information in the service management platform when an object whose state in the service management platform is a state of having not logged in exists in the one or plurality of objects.

Specific function implementation modes of the forming module 15, the competition applying module 16, the object obtaining unit 151, the successful forming unit 152 and the unsuccessful forming unit 153 may refer to step S201 to step S202 in the corresponding embodiments in FIG. 8 and will not be repeated in detail here.

In one or more embodiments, the state machine creating module 11 includes: a state obtaining unit 111, a state dividing unit 112 and a hierarchical state machine creation unit 113.

The state obtaining unit 111 is configured to obtain K platform states in the service management platform and obtain L service states matching the application. Both K and L are positive integers.

The state dividing unit 112 is configured to divide the K platform states and the L service states according to state paths between the K platform states and the L service states to obtain a state dividing result.

The hierarchical state machine creation unit 113 is configured to create a state machine with a hierarchical structure in the service management platform according to the state dividing result; states of different hierarchies in the state machine being used for processing different service logics in the application.

Specific function implementation modes of the state obtaining unit 111, the state dividing unit 112 and the hierarchical state machine creation unit 113 may refer to step S203 to step S205 in the corresponding embodiments in FIG. 8 and will not be repeated in detail here.

In one or more embodiments, the service progress data include room destruction information.

The state machine updating module 13 includes: a destruction information obtaining unit 131 and a first state switching unit 132.

The destruction information obtaining unit 131 is configured to obtain room destruction information corresponding to the service virtual room containing the target object when the service virtual room is destroyed.

The first state switching unit 132 is configured to perform state updating on the state machine according to the room destruction information and determine that a state of the state-updated state machine is a virtual room creation state; the virtual room creation state being used for indicating to recreate a new service virtual room in the application; and

the apparatus 1 for data synchronization may further include: a duration obtaining module 17 and a duration judgment module 18.

The duration obtaining module 17 is configured to obtain duration information that the state-updated state machine remains in the virtual room creation state.

The duration judgment module 18 is configured to update the state of state-updated state machine from the virtual room creation state to a preparing state when the duration information reaches a duration threshold.

In one or more embodiments, the service progress data include service start information.

The state machine updating module 13 includes: a start information obtaining unit 133 and a second state switching unit 134.

The start information obtaining unit 133 is configured to obtain the service start information corresponding to the target object in the service virtual room in response to that a service start state of the service virtual room is triggered.

The second state switching unit 134 is configured to perform state updating on the state machine according to the service start information and determine a state of the state-updated state machine as a service started state; the service started state being used for obtaining object service information of the target object in a competition process in the service virtual room.

In one or more embodiments, the service progress data include service end information.

The state machine updating module includes: an end information obtaining unit 135 and a third state switching unit 136.

The end information obtaining unit 135 is configured to obtain the service end information corresponding to the target object in the service virtual room in response to that a service end state of the service virtual room is triggered.

The third state switching unit 136 is configured to perform state updating on the state machine according to the service end information and determine that a state of the state-updated state machine is a result read state; the result read state being used for obtaining object service information of the target object in competition ending in the service virtual room.

Specific function implementation modes of the destruction information obtaining unit 131, the first state switching unit 132, the start information obtaining unit 133, the second state switching unit 134, the end information obtaining unit 135, the third state switching unit 136, the duration obtaining module 17 and the duration judgment module 18 may refer to description in the corresponding embodiments in FIG. 5 to FIG. 7 and will not be repeated in detail here.

In one or more embodiments, the apparatus 1 for data synchronization may further include: an information identification module 19 and a result showing module 20.

The information identification module 19 is configured to obtain a recognition model matching the object service information in the service management platform, input the object service information into the recognition model, and output an authenticity identification result corresponding to the object service information through the recognition model.

The result showing module 20 is configured to determine the object service information as a valid result of the target object when the authenticity identification result is a true result and show the valid result in the service management platform.

The above result showing module 20 is further configured to generate invalid result prompt information for the target object according to the object service information when the authenticity identification result is a false result, and show the invalid result prompt information in the service management platform.

In some embodiments, the number of target recognition models is N, and N is a positive integer.

The information identification module 19 includes: a model selection unit 191 and a result determining unit 192.

The model selection unit 191 is configured to obtain a recognition model set in the service management platform, and determine N recognition models matching the object service information from the recognition model set according to weight information and a model type corresponding to each recognition model in the recognition model set.

The result determining unit 192 is configured to input the object service information into the N recognition models respectively, output N recognition results corresponding to the object service information through the N recognition models, and determine the authenticity identification result corresponding to the object service information according to the N recognition models.

In one or more embodiments, the apparatus 1 for data synchronization may further include: a sample obtaining module 21, a predictive result outputting module 22 and a model training module 23.

The sample obtaining module 21 is configured to obtain sample data in a sample room in the application, and label the sample data to obtain label information corresponding to the sample data.

The predictive result outputting module 22 is configured to input the sample data into an initial recognition model, and output a predictive identification result corresponding to the sample data through the initial recognition model.

The model training module 23 is configured to revise a network parameter of the initial recognition model according to the label information and the predictive identification result to generate the trained recognition model, and issue the recognition model in the service management platform.

In some embodiments, the model training module 23 includes: a loss function determining unit 231 and a parameter revising unit 132.

The loss function determining unit 231 is configured to obtain a predictive distance between the label information and the predictive identification result, and determine a loss function corresponding to the initial recognition model according to the predictive distance.

The parameter revising unit 132 is configured to revise the network parameter of the initial recognition model by performing optimizing processing on the loss function, and determine the initial recognition model containing the revised network parameter as the trained recognition model.

Specific function implementation modes of the information identification module 19, the result showing module 20, the sample obtaining module 21, the predictive result outputting module 22, the model training module 23, the model selection unit 191, the result determining unit 192, the loss function determining unit 231 and the parameter revising unit 132 may refer to step S209 to step S210 in the corresponding embodiments in FIG. 8 and will not be repeated in detail here.

In this embodiment of this application, one or more applications may access the service platform data, when a first camp and a second camp match as competing camps, that is, when the platform virtual room is created, objects in the first camp and the second camp may be added into the same service virtual room of the application through the state machine corresponding to the created platform virtual room, data synchronization between the platform virtual room and the service virtual room may be implemented through the state machine, and the synchronization processing process may avoid the tedious operation of manual typing in information and improve the efficiency of synchronization processing of the object service information. By performing pinch hitting preventing detection on the object service information through one or more target recognition models, detection accuracy of the object service information may be improved, and fairness of the activity in the service management platform is guaranteed. Activities (such as an event competition) of the plurality of applications may be supported in the service management platform, the universality of a service management platform is improved, and manpower and cost in activity executing are reduced.

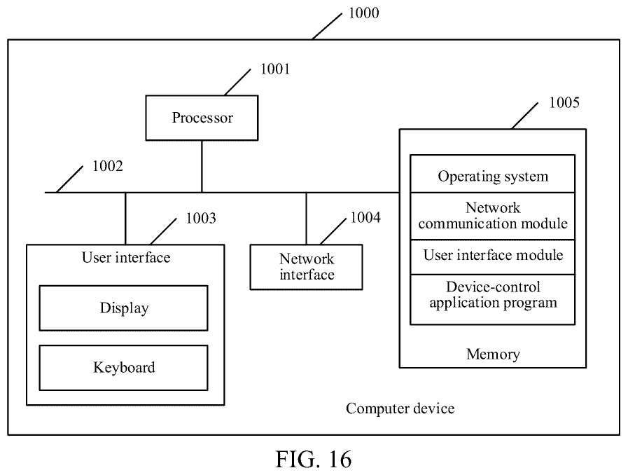

Further, please refer to FIG. 16, FIG. 16 is a schematic structural diagram of a computer device provided by an embodiment of this application. As shown in FIG. 16, the computer device 1000 may be a user terminal, or a server, which is not limited here. For convenient understanding, this application takes the computer device being the user terminal as an example, and the computer device 1000 may include: a processor 1001, a network interface 1004 and a memory 1005. Besides, the computer device 1000 may further include: a user interface 1003 and at least one communication bus 1002. The communication bus 1002 is configured to achieve connection communication between these components. The user interface 1003 may further include a standard wired interface and a standard wireless interface. The network interface 1004 may include a standard wired interface and a standard wireless interface (such as a WI-FI interface). The memory 1004 may be a high-speed RAM memory, or a non-volatile memory, for example, at least one magnetic disk memory. The memory 1005 may alternatively be at least one storage apparatus located away from the aforementioned processor 1001. As shown in FIG. 16, the memory 1005 used as a computer-readable storage medium may include an operating system, a network communication module, a user interface module, and a device-control application program.

The network interface 1004 in the computer device 1000 may further provide a network communication function, and the user interface 1003 may further include a display and a keyboard. In the computer device 1000 shown in FIG. 16, the network interface 1004 may provide the network communication function. The user interface 1003 is mainly configured to provide an input interface for a user. The processor 1001 may be configured to call the device-control application program stored in the memory 1005 so as to implement the method for data synchronization in the above various embodiments.

It is to be understood that the computer device 1000 described in this embodiment of this application may execute description of the method for data synchronization in any one corresponding embodiment in FIG. 3 and FIG. 8 described above, or may also execute description of the apparatus 1 for data synchronization in the corresponding embodiment in FIG. 15 described above, which will not be repeated in detail here. In addition, the description of beneficial effects of the same method are not described again.

Besides, an embodiment of this application further provides a computer-readable storage medium. The computer-readable storage medium stores a computer program executed by the apparatus 1 for data synchronization described above, the computer program includes a program instruction, and the processor, when executing the program instruction, is capable of executing description of the method for data synchronization in any one corresponding embodiment in FIG. 3 and FIG. 8 described above, which is not repeated in detail here. In addition, the description of beneficial effects of the same method are not described again. For technical details that are not disclosed in the computer-readable storage medium embodiment of this application, please refer to the descriptions of the method embodiment of this application. As an example, the program instruction may be deployed and executed on a computing device, or executed on a plurality of computing devices located in one place, or executed on a plurality of computing devices distributed in a plurality of places and interconnected through a communication network, and the plurality of computing devices distributed in the plurality of places and interconnected through the communication network may constitute a blockchain system.

Besides, an embodiment of this application further provides a computer program product or a computer program, the computer program product or the computer program may include a computer instruction, and the computer instruction may be stored in a computer-readable storage medium. A processor of a computer device reads the computer instruction from the computer-readable storage medium and may execute the computer instruction so as to cause the computer device to execute description of the method for data synchronization in any one corresponding embodiment in FIG. 3 and FIG. 8 described above, which will not be repeated in detail here. In addition, the description of beneficial effects of the same method are not described again. For technical details that are not disclosed in the computer program product or the computer program embodiments of this application, please refer to the descriptions of the method embodiment of this application.

To simplify the description, the foregoing method embodiments are described as a series of action combination. But persons of skill in the art are to know that this application is not limited by the described sequence of the actions, as some steps can adopt other sequences or can be executed simultaneously according to this application. In addition, persons of skill in the art are also to know that the related actions and modules in the embodiments described in the specification are not necessarily mandatory to this application.

The steps in the method of the embodiments of this application may be reordered, combined, or deleted according to an actual demand.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The modules or units in the apparatus of the embodiments of this application may be combined, divided or deleted according to an actual demand.

Persons of ordinary skill in the art may understand that all or a part of the processes of the method in the foregoing embodiment may be implemented by instructing related hardware by the computer program. The computer program may be stored in the computer-readable storage medium. When the program is executed, the processes in the foregoing method embodiment may be included. The storage medium may be a magnetic disc, an optical disc, a read-only memory (ROM), or a random access memory (RAM).

What is disclosed above is merely exemplary embodiments of this application, and certainly is not intended to limit the scope of the claims of this application. Therefore, equivalent variations made in accordance with the claims of this application still fall within the scope of this application.

What is claimed is:

1. A method for data synchronization performed by a computer device running a service management platform and the method comprising:
creating a state machine for a platform virtual room containing a target object in the service management platform;
creating a service virtual room in an application through the state machine, and adding the target object into the service virtual room;
receiving service progress data of the target object in the service virtual room through the state machine and updating the state machine accordingly to obtain a state-updated state machine; and
performing data synchronization processing on the platform virtual room according to the state-updated state machine and the service progress data of the service virtual room so as to synchronize object service information of the target object in the service virtual room into the platform virtual room.

2. The method according to claim 1, wherein the target object comprises M user groups, and M is a positive integer; and
the method further comprises:
forming M user groups from objects in the service management platform in response to a user group forming operation in the service management platform; the M user groups being associated with the application.

3. The method according to claim 2, wherein the user group forming operation comprises a forming sub-operation; and
the forming M user groups from objects in the service management platform in response to a user group forming operation in the service management platform comprises:
obtaining a plurality of objects determined by the forming sub-operation in the service management platform in response to the forming sub-operation in the service management platform; and
form an ith user group from the plurality of objects when all states of the plurality of objects in the management platform are a state of having logged in; the ith user group is one of the M user groups, and i is a positive integer smaller than or equal to M.

4. The method according to claim 1, wherein the state machine is a hierarchical state machine with a hierarchical structure; and states of different hierarchies in the hierarchical state machine are used for processing different service logics in the application.

5. The method according to claim 1, wherein the service progress data comprise room destruction information;
the receiving service progress data of the target object in the service virtual room through the state machine and updating the state machine accordingly to obtain a state-updated state machine comprise:
obtaining room destruction information corresponding to the service virtual room containing the target object when the service virtual room is destroyed; and
performing state updating on the state machine according to the room destruction information and determining that a state of the state-updated state machine is a virtual room creation state; and
the performing data synchronization processing on the platform virtual room comprises:
updating a first function control displayed in the platform virtual room into a second function control used for creating the service virtual room.

6. The method according to claim 1, wherein the service progress data comprise service start information;
the receiving service progress data of the target object in the service virtual room through the state machine and updating the state machine accordingly to obtain a state-updated state machine comprise:
obtaining the service start information corresponding to the target object in the service virtual room in response to that a service start state of the service virtual room is triggered; and
performing state updating on the state machine according to the service start information and determining that a state of the state-updated state machine is a service started state; the service started state being used for obtaining object service information of the target object in a service process in the service virtual room; and
the performing data synchronization processing on the platform virtual room comprises:
showing the object service information of the target object in the platform virtual room.

7. The method according to claim 1, wherein the service progress data comprise service end information;
the receiving service progress data of the target object in the service virtual room through the state machine and updating the state machine accordingly to obtain a state-updated state machine comprise:
obtaining the service end information corresponding to the target object in the service virtual room in response to that a service end state of the service virtual room is triggered; and
performing state updating on the state machine according to the service end information and determining that a state of the state-updated state machine is a result read state; the result read state being used for obtaining object service information of the target object in service ending in the service virtual room; and
the performing data synchronization processing on the platform virtual room comprises:
showing a service result of the target object in the platform virtual room.

8. The method according to claim 1, wherein, before the data synchronization processing, the method further comprises:
obtaining an authenticity identification result corresponding to the object service information by inputting the object service information into a recognition model;
determining the object service information as a valid result of the target object when the authenticity identification result is a true result and showing the valid result in the service management platform; and
generating invalid result prompt information for the target object according to the object service information when the authenticity identification result is a false result, and showing the invalid result prompt information in the service management platform.

9. A computer device, comprising a memory and a processor;
the memory being connected to the processor and configured to store a computer program that, when executed by the processor, causes the computer device to perform a method for data synchronization in a service management platform, the method including:
creating a state machine for a platform virtual room containing a target object in the service management platform;
creating a service virtual room in an application through the state machine, and adding the target object into the service virtual room;
receiving service progress data of the target object in the service virtual room through the state machine and updating the state machine accordingly to obtain a state-updated state machine; and
performing data synchronization processing on the platform virtual room according to the state-updated state machine and the service progress data of the service virtual room so as to synchronize object service information of the target object in the service virtual room into the platform virtual room.

10. The computer device according to claim 9, wherein the target object comprises M user groups, and M is a positive integer; and
the method further comprises:
forming M user groups from objects in the service management platform in response to a user group forming operation in the service management platform; the M user groups being associated with the application.

11. The computer device according to claim 10, wherein the user group forming operation comprises a forming sub-operation; and
the forming M user groups from objects in the service management platform in response to a user group forming operation in the service management platform comprises:
obtaining a plurality of objects determined by the forming sub-operation in the service management platform in response to the forming sub-operation in the service management platform; and
form an ith user group from the plurality of objects when all states of the plurality of objects in the management platform are a state of having logged in; the ith user group is one of the M user groups, and i is a positive integer smaller than or equal to M.

12. The computer device according to claim 9, wherein the state machine is a hierarchical state machine with a hierarchical structure; and states of different hierarchies in the hierarchical state machine are used for processing different service logics in the application.

13. The computer device according to claim 9, wherein the service progress data comprise room destruction information;
the receiving service progress data of the target object in the service virtual room through the state machine and updating the state machine accordingly to obtain a state-updated state machine comprise:
obtaining room destruction information corresponding to the service virtual room containing the target object when the service virtual room is destroyed; and
performing state updating on the state machine according to the room destruction information and determining that a state of the state-updated state machine is a virtual room creation state; and
the performing data synchronization processing on the platform virtual room comprises:
updating a first function control displayed in the platform virtual room into a second function control used for creating the service virtual room.

14. The computer device according to claim 9, wherein the service progress data comprise service start information;
the receiving service progress data of the target object in the service virtual room through the state machine and updating the state machine accordingly to obtain a state-updated state machine comprise:
obtaining the service start information corresponding to the target object in the service virtual room in response to that a service start state of the service virtual room is triggered; and
performing state updating on the state machine according to the service start information and determining that a state of the state-updated state machine is a service started state; the service started state being used for obtaining object service information of the target object in a service process in the service virtual room; and
the performing data synchronization processing on the platform virtual room comprises:
showing the object service information of the target object in the platform virtual room.

15. The computer device according to claim 9, wherein the service progress data comprise service end information;
the receiving service progress data of the target object in the service virtual room through the state machine and updating the state machine accordingly to obtain a state-updated state machine comprise:
obtaining the service end information corresponding to the target object in the service virtual room in response to that a service end state of the service virtual room is triggered; and
performing state updating on the state machine according to the service end information and determining that a state of the state-updated state machine is a result read state; the result read state being used for obtaining object service information of the target object in service ending in the service virtual room; and
the performing data synchronization processing on the platform virtual room comprises:
showing a service result of the target object in the platform virtual room.

16. The computer device according to claim 9, wherein, before the data synchronization processing, the method further comprises:
obtaining an authenticity identification result corresponding to the object service information by inputting the object service information into a recognition model;
determining the object service information as a valid result of the target object when the authenticity identification result is a true result and showing the valid result in the service management platform; and
generating invalid result prompt information for the target object according to the object service information when the authenticity identification result is a false result, and showing the invalid result prompt information in the service management platform.

17. A non-transitory computer-readable storage medium, storing a computer program that, when executed by a processor of a computer device, causes the computer device to perform a method for data synchronization in a service management platform, the method including:
creating a state machine for a platform virtual room containing a target object in the service management platform;
creating a service virtual room in an application through the state machine, and adding the target object into the service virtual room;
receiving service progress data of the target object in the service virtual room through the state machine and updating the state machine accordingly to obtain a state-updated state machine; and
performing data synchronization processing on the platform virtual room according to the state-updated state machine and the service progress data of the service virtual room so as to synchronize object service information of the target object in the service virtual room into the platform virtual room.

18. The non-transitory computer-readable storage medium according to claim 17, wherein the target object comprises M user groups, and M is a positive integer; and
the method further comprises:
forming M user groups from objects in the service management platform in response to a user group forming operation in the service management platform; the M user groups being associated with the application.

19. The non-transitory computer-readable storage medium according to claim 18, wherein the user group forming operation comprises a forming sub-operation; and
the forming M user groups from objects in the service management platform in response to a user group forming operation in the service management platform comprises:
obtaining a plurality of objects determined by the forming sub-operation in the service management platform in response to the forming sub-operation in the service management platform; and
form an ith user group from the plurality of objects when all states of the plurality of objects in the management platform are a state of having logged in; the ith user group is one of the M user groups, and i is a positive integer smaller than or equal to M.

20. The non-transitory computer-readable storage medium according to claim 17, wherein the state machine is a hierarchical state machine with a hierarchical structure; and states of different hierarchies in the hierarchical state machine are used for processing different service logics in the application.
